(19) United States
(12) Patent Application Publication
(10) Pub. No.: US 2020/0062889 A1
(43) Pub. Date: Feb. 27, 2020

(54) THERMOSETTING RESIN COMPOSITION

(71) Applicant: Shengyi Technology Co., Ltd., Guangdong (CN)

(72) Inventors: Cheng LUO, Guangdong (CN); Guofang TANG, Guangdong (CN); Jiangling ZHANG, Guangdong (CN)

(21) Appl. No.: 16/466,092

(22) PCT Filed: Feb. 21, 2017
(86) PCT No.: PCT/CN2017/074297

§ 371 Date: Jun. 3, 2019

(30) Foreign Application Priority Data
Dec. 7, 2016 (CN) 201611115128.8

(51) Int. Cl. C08G 59/40; C08L 63/00

(52) U.S. Cl. CPC C08G 59/4071; C08L 2201/22; C08L 2201/02; C08L 63/00

(57) ABSTRACT

Provided in the present invention is a thermosetting resin composition, comprising phosphorus-containing active ester and epoxy resin, the phosphorus-containing active ester being copolymerised using bis-aromatic formyl chloride hydrocarbyl phosphine oxide and one of bis-hydroxyl aromatic hydrocarbyl phosphine oxide, bis-hydroxyl aromatic oxyhydrocarbyl phosphine oxide, or hydroxylated DOPO, and then obtained from aromatic formyl chloride end capping; the thermosetting resin composition provided in the present invention has the advantages of good thermal stability, humidity resistance and heat resistance, a low dielectric constant and dielectric loss tangent, a low rate of water absorption, and halogen-free flame-retardant properties, and has excellent machinability; also provided in the present invention are applications of the thermosetting resin composition for resin sheet material, resin composite metal foil, prepreg, laminated plate, metal foil-clad laminated plate, and printed circuit boards.

### TECHNICAL FIELD

The present invention relates to the technical field of polymer materials, in particular to a thermosetting resin composition, as well as a prepreg and a printed circuit board using the same.

### BACKGROUND ART

Conventional printed circuit laminates usually achieve flame retardancy by using brominated flame retardants, especially tetrabromo-bisphenol A epoxy resin which has good flame retardancy, but will produce hydrogen bromide gas during combustion. Furthermore, carcinogens such as dioxins and dibenzofurans have been detected in recent years in combustion products of electrical and electronic equipment wastes containing halogens such as bromine and chlorine. Thus the application of brominated epoxy resins is limited. Two EU environmental directives of Waste Electrical and Electronic Equipment Directive and the Restriction of the Use of Certain Hazardous Substances in Electrical and Electronic Equipment have been officially implemented on Jul. 1, 2006. The development of halogen-free flame retardant copper-clad laminates has become a hot spot in the industry, and various CCL manufacturers have launched their own halogen-free flame retardant copper-clad laminates.

The introduction of a phosphorus-containing compound into the resin matrix of copper-clad laminates has become the main technical route for the halogen-free flame retardancy of copper-clad laminates. At present, phosphorus-based flame retardants widely used in the field of copper-clad laminates are mainly classified into two types, i.e. reactive type and additive type. The reactive type mainly involves DOPO-based compounds primarily comprising phosphorus-containing epoxy resins and phosphorus-containing phenolic resins and having a phosphorus content of 2-10%. However, it has been found in practical applications that DOPO-based compounds have a large water absorption rate, poor dielectric properties, and worse heat and humidity resistance. The additive type mainly relates to phosphazene and phosphonate compounds. The additive flame retardant has a low flame retardancy efficiency, and cannot achieve the flame retardant requirement unless adding more. Meanwhile, it is easy to migrate to the surface of the sheet during the processing of laminates due to its lower melting point (generally lower than 150° C.), thus affecting the performances of the sheet.

In addition, in order to meet the processability of the PCB and the performance requirements of the terminal electronic product, it is necessary for copper-clad substrate materials to have good dielectric properties, heat resistance and mechanical properties, and also to have good processing characteristics, high peel strength and excellent heat and humidity resistance.

Dicarboxyphenyl hydrocarbyl phosphine oxide is a reactive phosphorus-containing curing agent, and dihydroxyphenyl hydrocarbyl phosphine oxide and hydroxy-containing phosphaphenanthrene can be cured with epoxy resins, but the reactive groups thereof which are carboxyl groups or hydroxyl groups will produce more secondary hydroxyl groups with a large polarity after the reaction with epoxy resin, resulting in poor dielectric properties of the cured product. Moreover, carboxyl groups and hydroxyl groups are highly reactive, resulting in extremely difficult processing control thereof. CN103384674A discloses a composition composed of polyphosphonate or/and a phosphonate-carbonate copolymer having hydroxyl groups and an epoxy, wherein the active group is a phenolic hydroxyl group, which also has the problem of poor dielectric properties. CN103694642A discloses using epoxy resins, cyanate compounds or/and cyanate prepolymers, polyphosphonate or/and phosphonate-carbonate copolymers for the preparation of halogen-free UL94 V-0 flame retardant having good dielectric properties and good heat and humidity resistance. However, it has a lower peel strength, interlayer adhesion and flexural strength.

### DISCLOSURE OF THE INVENTION

The inventors found by research that the phosphorus-containing active ester with a special structure as the curing agent of epoxy resins does not generate secondary hydroxyl groups with a large polarity when reacting with the epoxy resins, so as to make the system have good dielectric properties. Meanwhile, it is a phosphorus-containing active ester curing agent, and has a halogen-free flame retardant effect when used as a curing agent. Moreover, it has a high flame retardant efficiency, and can make the sheets reach UL94 V-0 halogen-free flame retardant effect when added in a small amount or without adding other flame retardants.

On such a basis, one of the objects of the present invention is to provide a thermosetting resin composition, as well as a prepreg and a laminate for printed circuit boards using the same. The laminate for printed circuit boards produced using the resin composition has high glass transition temperature, excellent dielectric properties, high heat resistance, excellent peel strength and good processability, and can achieve halogen-free flame retardancy and reach UL94 V-0.

The present inventors conducted intensive studies in order to achieve the above object, and found, as a result, that a composition obtained by appropriately mixing an epoxy resin, a phosphorus-containing active ester having a special structure, and optionally other curing agents can achieve the above object.

That is to say, the present invention discloses the following technical solution, i.e. a thermosetting resin composition comprising an epoxy resin and a curing agent, wherein the curing agent comprises at least one phosphorus-containing active ester having a special structure.

The thermosetting resin composition of the present invention uses a phosphorus-containing active ester having a special structure as a curing agent for an epoxy resin. The active ester group as a reactive group has a high content, and can be cured with an epoxy resin to obtain a cured product having a high crosslinking density, so as to obtain a material having high heat resistance and high Tg. The phosphorus-containing active ester having a special structure contains aromatic groups in a high content, which has a positive effect on the glass transition temperature and flame retardancy. The active ester unit in the molecule does not generate secondary hydroxyl groups having a large polarity after reacting with the epoxy resin, which can eliminate the disadvantage of poor dielectric properties brought by secondary hydroxyl groups having a large polarity, so as to make excellent dielectric properties. The ester bond formed by the reaction of the phosphorus-containing active ester having a special structure with the epoxy has a low water absorption rate, thereby improving the disadvantages of poor heat and humidity resistance of the phosphorus-containing compounds. In addition, the phosphorus-containing active ester having a special structure contains phosphorus in the main structural monomers thereof, and have a high overall phosphorus content, which can achieve a halogen-free flame retardant effect. Moreover, it has a high flame retardant efficiency, and can reach UL94 V-0 flame retardant effect when added in a small amount or without adding other flame retardants.

The present invention discloses utilizing a phosphorus-containing active ester having a highly symmetrical special structure, which can significantly improve the glass transition temperature and heat resistance of a prepreg and a laminate for printed circuit boards made from the resin composition, and make them have excellent dielectric properties, low water absorption, good heat and humidity resistance and good processability, and can achieve halogen-free flame retardancy and reach UL94 V-0. The components are described in detail below.

According to the present invention, the phosphorus-containing active ester is obtained by copolymerizing a diarylformylchlorohydrocarbylphosphine oxide with at least one of a dihydroxyarylhydrocarbylphosphine oxide, a dihydroxyaryloxyhydrocarbylphosphine oxide and a hydroxylated DOPO, and then terminating by an aromatic formyl chloride, wherein

said diarylformylchlorohydrocarbylphosphine oxide has a structural formula of Formula (I),

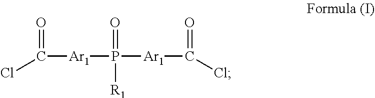

said dihydroxyarylhydrocarbylphosphine oxide has a structural formula of Formula (II),

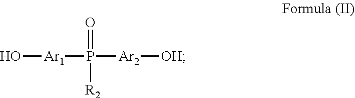

said dihydroxyaryloxyhydrocarbylphosphine oxide has a structural formula of Formula (III),

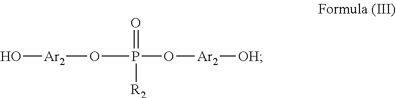

said hydroxylated DOPO has a structural formula of Formula (IV),

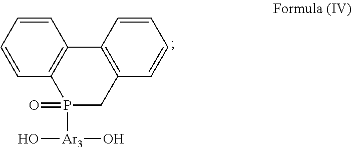

said aromatic formyl chloride has a structural formula of Formula (V),

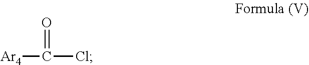

wherein R₁ and R₂ are identical or different from each other, and each independently anyone selected from the group consisting of phenyl, naphthyl, and linear or branched alkyl having 1 to 4 carbon atoms, wherein the linear or branched alkyl having 1 to 4 carbon atoms is anyone selected from the group consisting of methyl, ethyl, propyl, butyl, isopropyl, isobutyl, and tert-butyl;
wherein Ar₁ and Ar₂ are identical or different from each other, and each independently anyone selected from the group consisting of

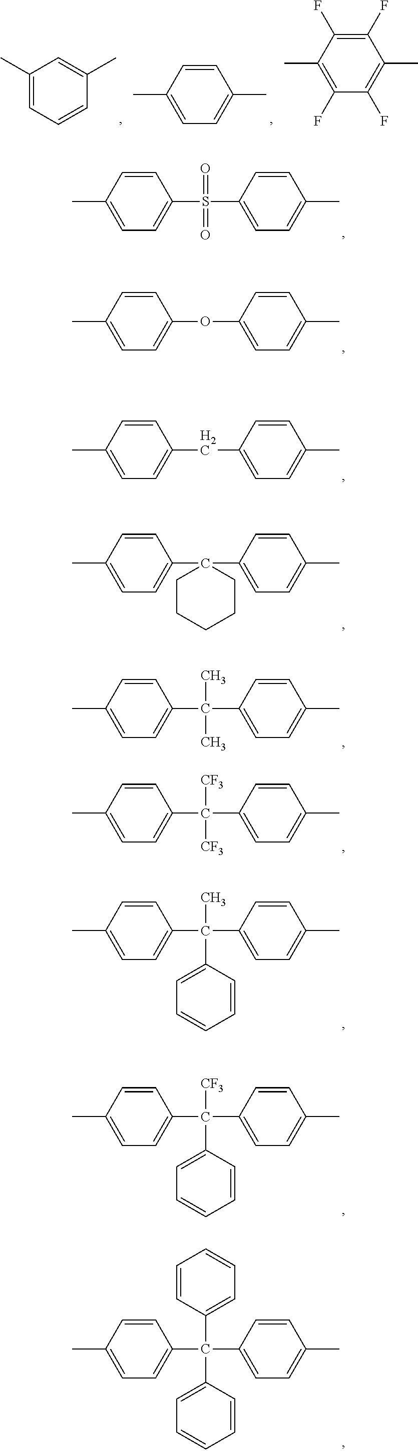

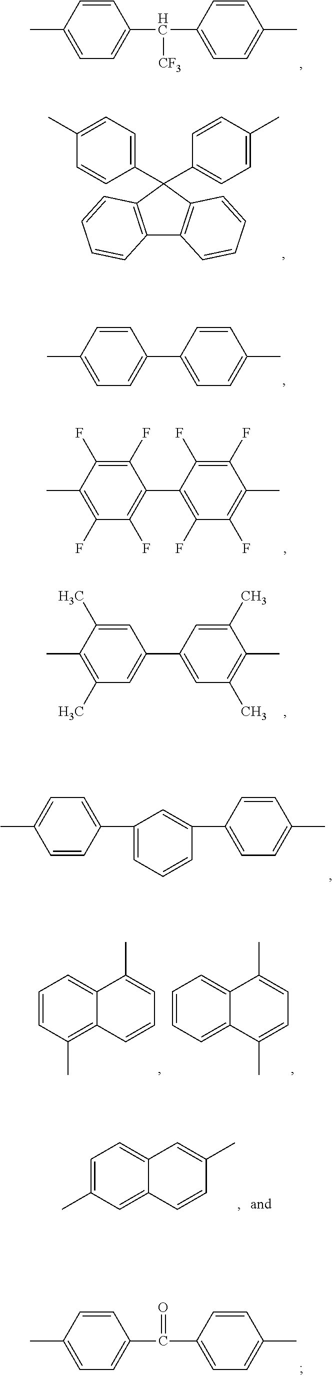

wherein Ar₃ is anyone selected from the group consisting of

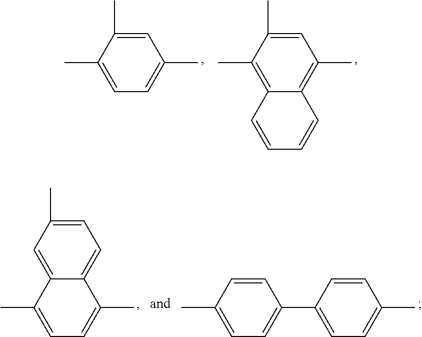

wherein Ar₄ is anyone selected from the group consisting of

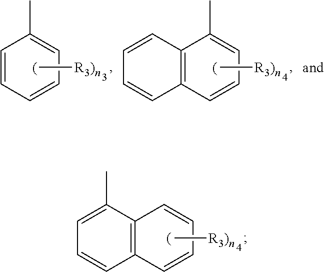

wherein n₃ is an integer of 0-5, e.g. 0, 1, 2, 3, 4 or 5;
wherein n₄ is an integer of 0-7, e.g. 0, 1, 2, 3, 4, 5, 6 or 7;
wherein R₃ is anyone selected from the group consisting of linear or branched alkyl groups having 1 to 4 carbon atoms, e.g. anyone selected from the group consisting of methyl, ethyl, propyl, butyl, isopropyl, isobutyl, and tert-butyl.

Preferably, the phosphorus-containing active ester is obtained by copolymerizing a diarylformylchlorohydrocarbylphosphine oxide with a dihydroxyarylhydrocarbylphosphine oxide and then terminating by an aromatic formyl chloride, wherein the phosphorus-containing active ester has a structural formula of formula (VI),

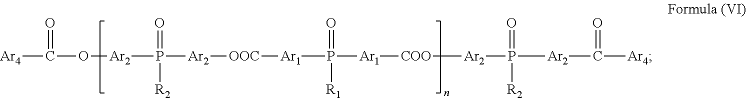

specifically, the structural formula can be the following structure,

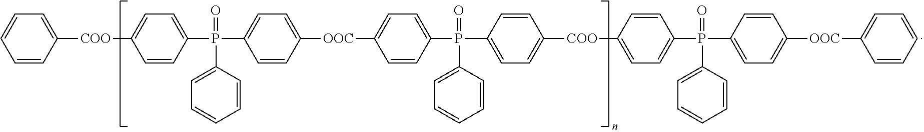

Preferably, the phosphorus-containing active ester is obtained by copolymerizing a diarylformylchlorohydrocarbylphosphine oxide with a dihydroxyaryloxyhydrocarbylphosphine oxide and then terminating by an aromatic formyl chloride, wherein the phosphorus-containing active ester has a structural formula of formula (VII),

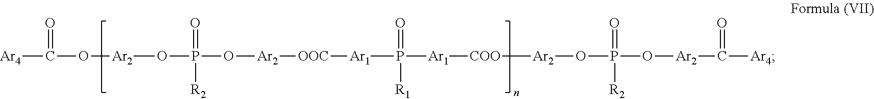

specifically, the structural formula can be the following structure,

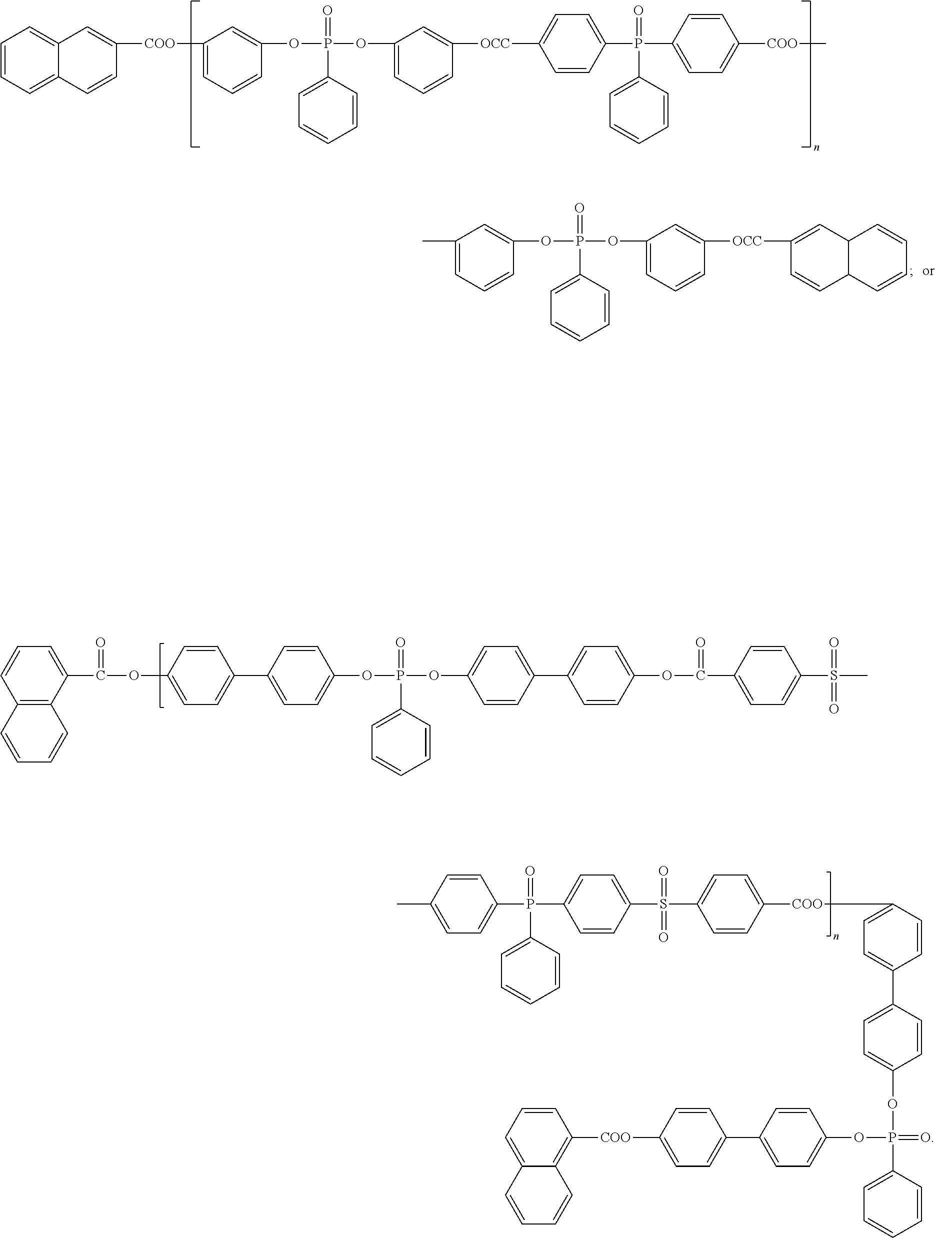

Preferably, the phosphorus-containing active ester is obtained by copolymerizing a diarylformylchlorohydrocarbylphosphine oxide with a hydroxylated DOPO and then terminating by an aromatic formyl chloride, wherein the phosphorus-containing active ester has a structural formula of formula (VIII),

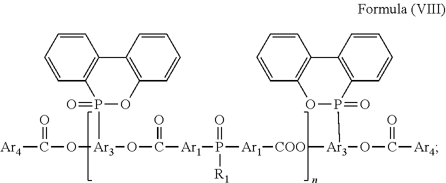

specifically, the structural formula can be the following structure,

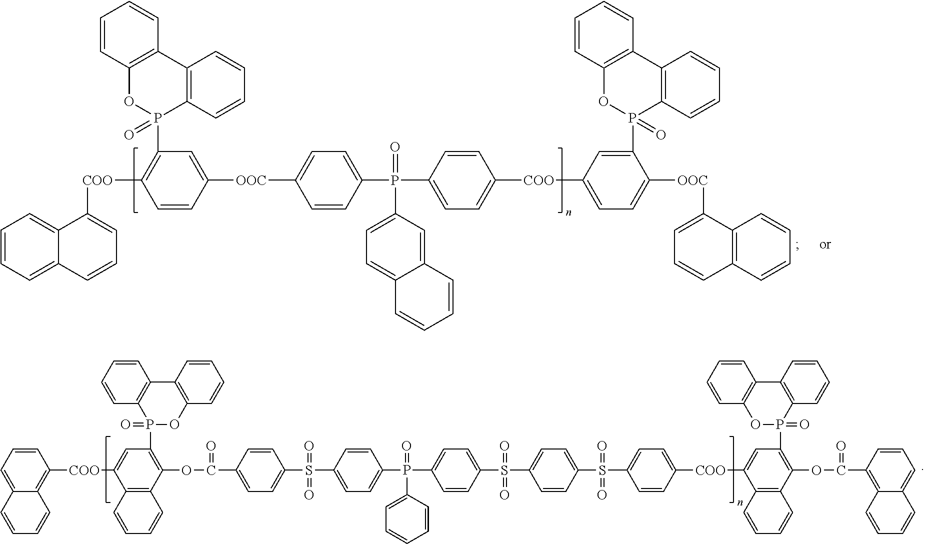

Preferably, the phosphorus-containing active ester is obtained by copolymerizing a diarylformylchlorohydrocarbylphosphine oxide with a dihydroxyaryloxyhydrocarbylphosphine oxide and a hydroxylated DOPO and then terminating by an aromatic formyl chloride, wherein the phosphorus-containing active ester has a structural formula of formula (IX) or (X),

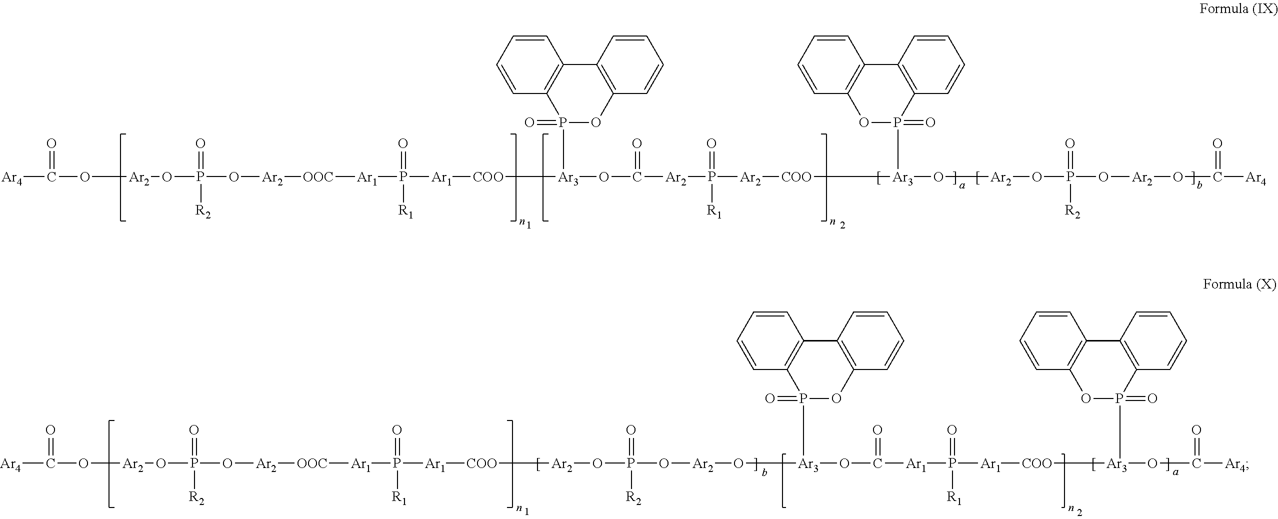

specifically, the structural formula can be the following structures,

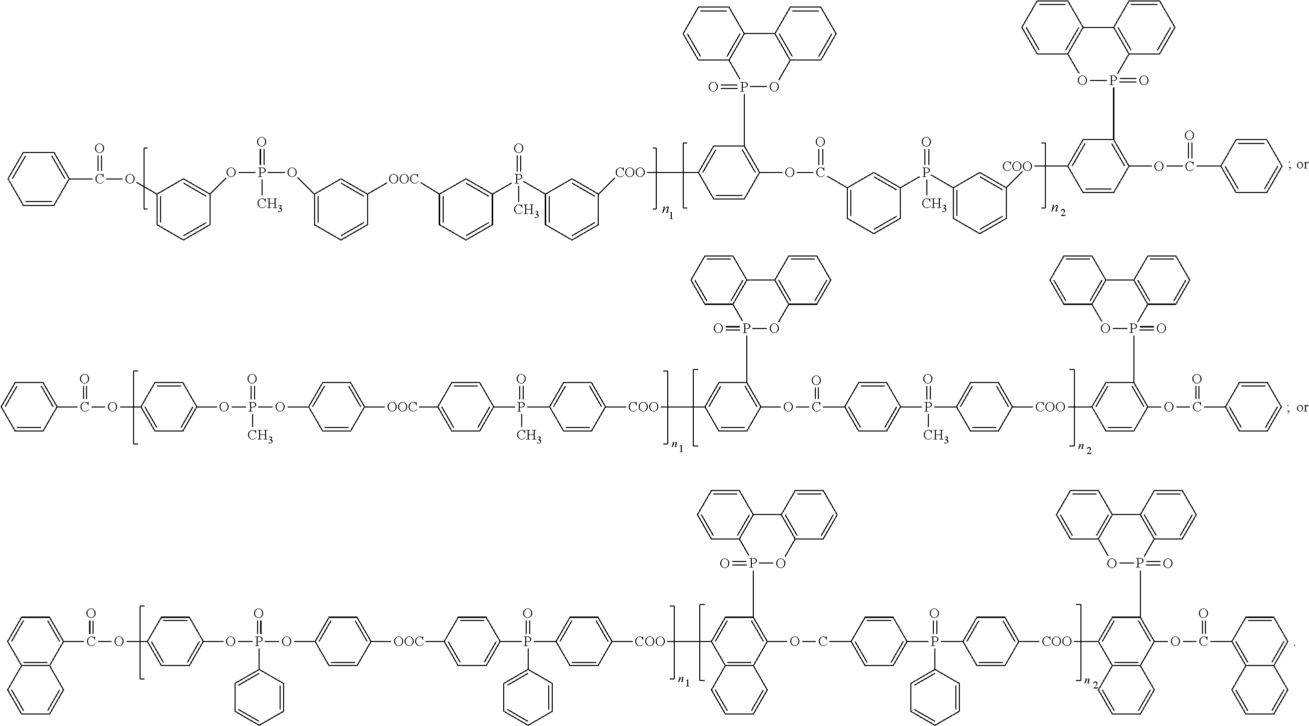

The phosphorus-containing active ester of the present invention can also be obtained by copolymerizing a diarylformylchlorohydrocarbylphosphine oxide with a dihydroxyaryloxyhydrocarbylphosphine oxide and a dihydroxyarylhydrocarbylphosphine oxide and then terminating by an aromatic formyl chloride, wherein the phosphorus-containing active ester has a structural formula of formula (XI),

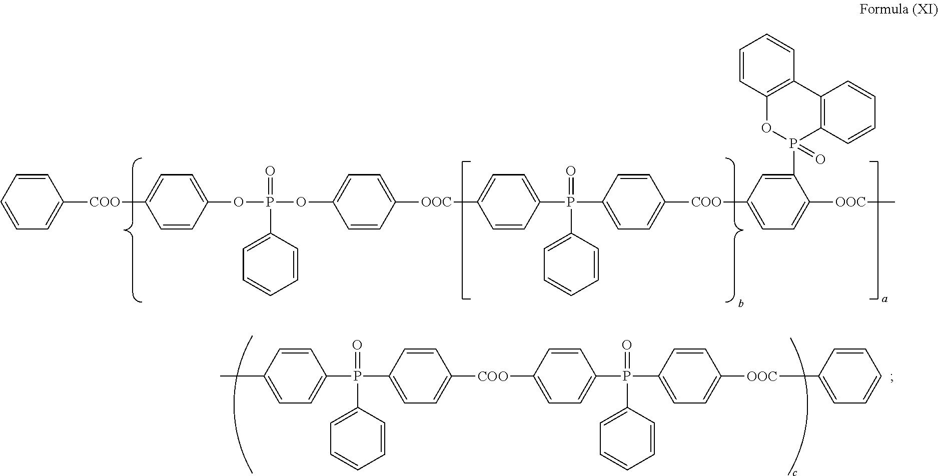

wherein n is an integer of 1-20, e.g. 1, 2, 3, 4, 5, 6, 7, 8, 9, 10, 11, 12, 13, 14, 15, 16, 17, 18, 19 or 20; wherein each of n₁ and n₂ is an integer of 0-20, e.g. 0, 1, 2, 3, 4, 5, 6, 7, 8, 9, 10, 11, 12, 13, 14, 15, 16, 17, 18, 19 or 20, and 1≤n₁+n₂≤20, e.g. n₁ is 0, and n₂ is 1; or n₁ is 1, and n₂ is 3; or n₁ is 1, and n₂ is 19;
wherein each of a and b is 0 or 1, and a+b=1, e.g. a is 0, and b is 1; or a is 1, and b is 0;
wherein b must be 0 when n₁ is 0;
wherein a must be 0 when n₂ is 0;
wherein R₁ and R₂ are identical or different from each other, and each independently anyone selected from the group consisting of phenyl, naphthyl, and linear or branched alkyl having 1 to 4 carbon atoms, wherein the linear or branched alkyl having 1 to 4 carbon atoms is anyone selected from the group consisting of methyl, ethyl, propyl, butyl, isopropyl, isobutyl, and tert-butyl;
wherein Ar₁ and Ar₂ are identical or different from each other, and each independently anyone selected from the group consisting of

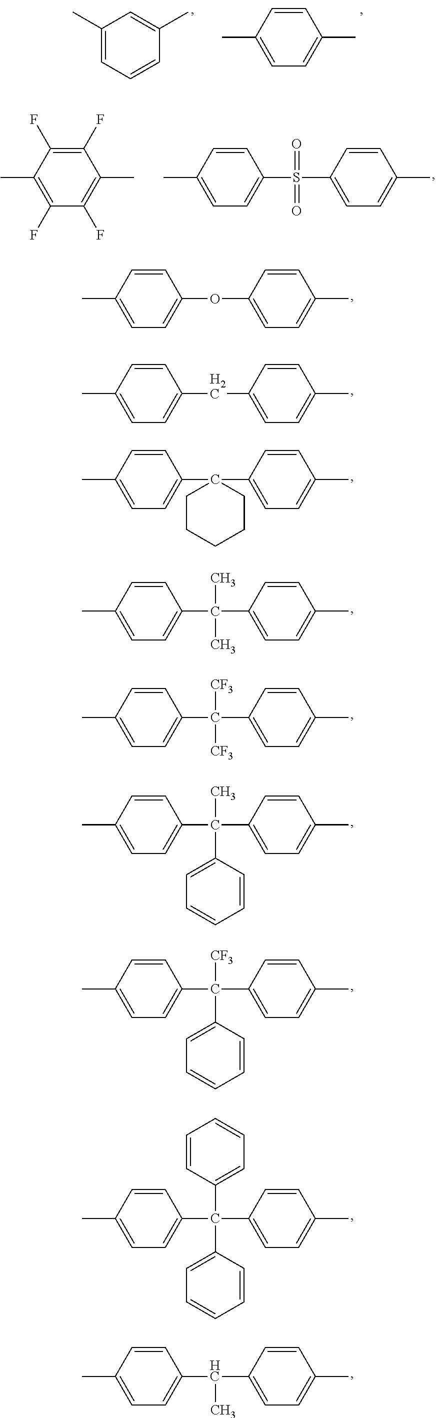

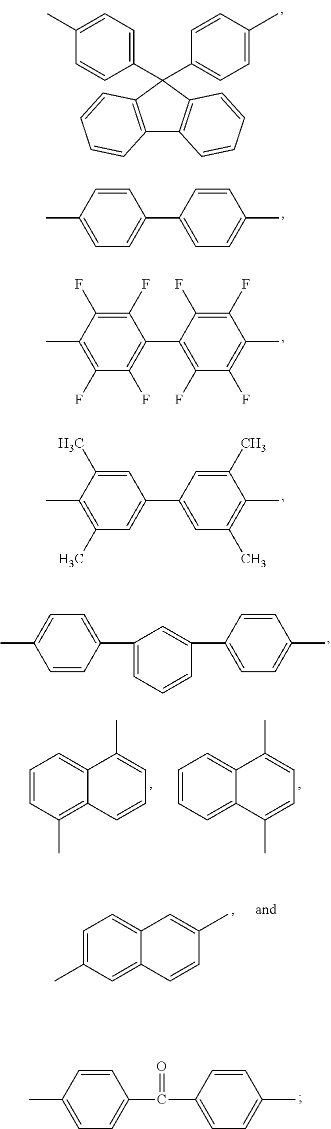

wherein Ara is anyone selected from the group consisting of

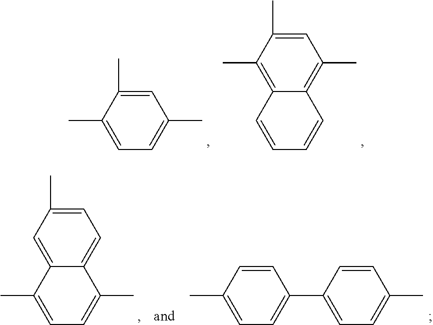

wherein Ar₄ is anyone selected from the group consisting of

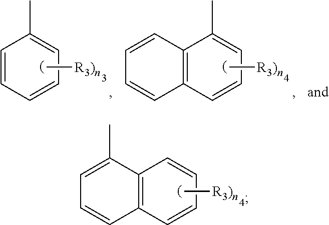

wherein n₃ is an integer of 0-5, e.g. 0, 1, 2, 3, 4 or 5;
wherein n₄ is an integer of 0-7, e.g. 0, 1, 2, 3, 4, 5, 6 or 7;
wherein R₃ is anyone selected from the group consisting of linear or branched alkyl groups having 1 to 4 carbon atoms, e.g. anyone selected from the group consisting of methyl, ethyl, propyl, butyl, isopropyl, isobutyl, and tert-butyl.

According to the present invention, the phosphorus-containing active ester is present in an amount of 10% to 60% by weight of the total weight of the epoxy resin and the curing agent in the thermosetting resin composition, e.g. 10%, 15%, 20%, 22%, 24%, 25%, 26%, 28%, 30%, 32%, 35%, 38%, 40%, 42%, 45%, 48%, 50%, 55% or 60%, as well as any specific value between said values. Due to space limitations and concise considerations, the present invention no longer enumerates exhaustively the specific point values included in the scope.

According to the present invention, the epoxy resin is present in an amount of 30% to 60% by weight of the total weight of the epoxy resin and the curing agent in the thermosetting resin composition, e.g. 30%, 32%, 34%, 35%, 36%, 38%, 40%, 42%, 45%, 48%, 50%, 52%, 55%, 58% or 60%, as well as any specific value between said values. Due to space limitations and concise considerations, the present invention no longer enumerates exhaustively the specific point values included in the scope.

The present invention discloses preferably using a halogen-free epoxy resin which refers to an epoxy resin having two or more epoxy groups in one molecule, specifically may be anyone selected from the group consisting of glycidyl ethers, glycidyl esters, glycidyl amines, alicyclic epoxy resins, epoxidized olefins, hydantoin epoxy resins, imide epoxy resins, and a mixture of at least two selected therefrom. The typical but non-limitative mixtures are selected from the group consisting of glycidyl ethers and glycidyl esters, alicyclic epoxy resins and epoxidized olefins, glycidyl amines and hydantoin epoxy resins.

Preferably, the glycidyl ethers include bisphenol A epoxy resin, bisphenol F epoxy resin, o-cresol novolac epoxy resin, bisphenol A novolac epoxy resin, trisphenol novolac epoxy resin, dicyclopentadiene novolac epoxy resin, biphenyl type novolac epoxy resin, alkylbenzene novolac epoxy resin, naphthol novolac epoxy resin, and a mixture of at least two selected therefrom.

Further preferably, the glycidyl ether is selected from the group consisting of epoxy resins having the following structure:

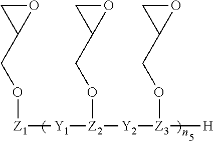

wherein Z₁, Z₂ and Z₃ are each independently selected from the group consisting of

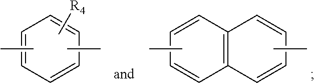

R₄ is anyone selected from the group consisting of hydrogen atom and substituted or unsubstituted linear or branched alkyl groups having a carbon number of 1-5, e.g. anyone selected from the group consisting of methyl, ethyl, propyl, butyl, pentyl, isopropyl, isobutyl, tert-butyl, and isopentyl;
wherein Y₁ and Y₂ are each independently anyone selected from the group consisting of —CH₂—,

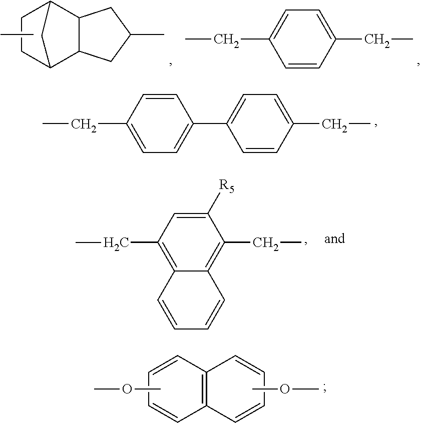

R₅ is anyone selected from the group consisting of hydrogen atom and substituted or unsubstituted linear or branched alkyl groups having a carbon number of 1-5, e.g. anyone selected from the group consisting of methyl, ethyl, propyl, butyl, pentyl, isopropyl, isobutyl, tert-butyl, and isopentyl;
wherein n₅ is an integer of 1-10, e.g. 1, 2, 3, 4, 5, 6, 7, 8, 9 or 10.

Preferably, said glycidyl amines are anyone selected from the group consisting of triglycidyl-p-aminophenol, triglycidyl trimeric isocyanate, tetraglycidyldiamino-dimethylenebenzene, tetraglycidyl-4,4′-diaminodiphenylmethane, tetraglycidyl-3,4′-diaminodiphenyl ether, tetraglycidyl-4,4′-diaminodiphenyl ether, tetraglycidyl-1,3-diaminomethylcyclohexane, and a mixture of at least two selected therefrom.

The halogen-free thermosetting resin composition of the present invention comprises the halogen-free epoxy resin having the specific molecular structure described above, which has high functionality and good dielectric properties. The cured product thereof has a high Tg and a low water absorption rate.

According to the present invention, the curing agent may further comprise a cyanate resin and/or a bismaleimide-triazine resin, wherein the cyanate resin has the following structure,

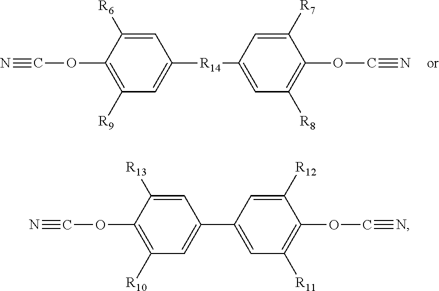

wherein R₁₄ is anyone selected from the group consisting of —CH₂—,

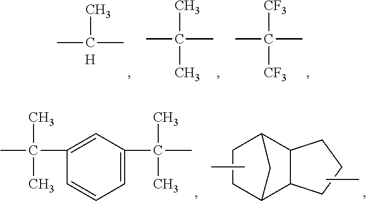

and a mixture of at least two selected therefrom; R₆, R₇, R₈, R₉, R₁₀, R₁₁, R₁₂ and R₁₃ are each independently anyone selected from the group consisting of hydrogen atom and substituted or unsubstituted linear or branched alkyl groups having a carbon number of 1-4, e.g. anyone selected from the group consisting of methyl, ethyl, propyl, butyl, isopropyl, isobutyl, and tert-butyl.

Preferably, said cyanate resin is anyone selected from the group consisting of 2,2-bis(4-cyanooxyphenyl)propane, bis(4-cyanooxyphenyl)ethane, bis(3,5-dimethyl-4-cyano-oxyphenyl)methane, 2,2-bis(4-cyanooxyphenyl)-1,1,1,3,3,3-hexafluoropropane, α,α′-bis(4-cyanooxyphenyl)-m-diisopropylbenzene, cyclopentadiene type cyanate, phenol novolac type cyanate, cresol novolac type cyanate, 2,2-bis(4-cyanooxyphenyl) propane prepolymer, bis(4-cyanoxyphenyl)ethane prepolymer, bis(3,5-dimethyl-4-cyanooxyphenyl)methane prepolymer, 2,2-bis(4-cyanooxyphenyl)-1,1,1,3,3,3-hexa-fluoropropane prepolymer, α,α′-bis(4-cyanooxyphenyl)-m-diisopropylbenzene prepolymer, dicyclopentadiene type cyanate polymer, phenol novolac type cyanate prepolymer, cresol novolac type cyanate prepolymer, and a mixture of at least two selected therefrom, preferably anyone selected from the group consisting of 2,2-bis-(4-cyanooxyphenyl)propane, α,α′-bis(4-cyanooxyphenyl)-m-diisopropylbenzene, bis-(3,5-dimethyl-4-cyanooxyphenyl)methane, 2,2-bis(4-cyanooxyphenyl)propane prepolymer, α,α′-bis(4-cyanooxyphenyl)-m-diisopropylbenzene prepolymer, bis-(3,5-dimethyl-4-cyanooxyphenyl)methane prepolymer, and a mixture of at least two selected therefrom.

According to the present invention, the cyanate resin and/or the bismaleimide-triazine resin are/is present in an amount of 0% to 50% by weight of the total weight of the epoxy resin and the curing agent in the thermosetting resin composition, e.g. 0%, 2%, 4%, 5%, 8%, 10%, 12%, 14%, 15%, 17%, 20%, 22%, 25%, 30%, 32%, 35%, 37%, 39%, 40%, 42%, 45%, 48% or 50%, as well as any specific value between said values. Due to space limitations and concise considerations, the present invention no longer enumerates exhaustively the specific point values included in the scope.

According to the present invention, the curing agent further comprises a SMA resin which refers to a styrene-maleic anhydride resin and can be obtained by copolymerization of styrene and maleic anhydride in a ratio of 1:1 to 8:1.

According to the present invention, said SMA resin is present in an amount of 0%-40% by weight of the total weight of the epoxy resin and the curing agent in the thermosetting resin composition, e.g. 0%, 2%, 4%, 5%, 8%, 10%, 12%, 14%, 15%, 17%, 20%, 22%, 25%, 30%, 32%, 35%, 37%, 39% or 40%, as well as any specific value between said values. Due to space limitations and concise considerations, the present invention no longer enumerates exhaustively the specific point values included in the scope.

According to the present invention, the curing agent may further comprises a phenolic resin which refers to a phenolic resin containing phosphorus or not, and is selected from the well-known phenolic resins in the art. The present invention is not specifically limited.

According to the present invention, the phenolic resin is present in an amount of 0%-20% by weight of the total weight of the epoxy resin and the curing agent in the thermosetting resin composition, e.g. 0%, 2%, 4%, 5%, 8%, 10%, 12%, 14%, 15%, 17% or 20%, as well as any specific value between said values. Due to space limitations and concise considerations, the present invention no longer enumerates exhaustively the specific point values included in the scope.

The thermosetting resin composition of the present invention, based on 100 parts by weight of organic solids, specifically comprises 10-60 parts by weight of a phosphorus-containing active ester, 30-60 parts by weight of a halogen-free epoxy resin, 0-50 parts by weight of a cyanate resin and/or a bismaleimide-triazine resin, 0-40 parts by weight of a SMA resin, and 0-20 parts by weight of a phenolic resin.

The “total weight of the epoxy resin and the curing agent in the thermosetting resin composition” referred to in the present invention means the total weight of the components participating in the crosslinking polymerization reaction, wherein the curing agent refers to the phosphorus-containing active ester having the function of curing the epoxy resin, and optionally the cyanate resin and/or the bismaleimide-triazine resin, the SMA resin or the phenolic resin, which does not contain fillers, accelerators and flame retardants.

The thermosetting resin composition of the present invention may further comprise an organic halogen-free flame retardant which may be specifically selected from phosphorus-containing flame retardants.

According to the present invention, the phosphorus-containing flame retardant may be anyone selected from the group consisting of tris(2,6-dimethylphenyl)phosphine, 10-(2,5-dihydroxyphenyl)-9,10-dihydro-9-oxa-10-phosphaphenanthrene-10-oxide, 2,6-bis(2,6-dimethylphenyl)phosphinobenzene, 10-phenyl-9,10-dihydro-9-oxa-10-phosphaphenanthrene-10-oxide, phenoxyphosphazene compound, phosphate, polyphosphate, polyphosphonate, phosphonate-carbonate copolymer, and a mixture of at least two selected therefrom.

In the present invention, the organic halogen-free flame retardant is present in an amount of 0-15 parts by weight, based on 100 parts by weight of the total weight of the epoxy resin and the curing agent in the thermosetting resin composition. That is to say, the organic halogen-free flame retardant is added in an amount of 0 to 15 parts by weight, based on 100 parts by weight of the total weight of the phosphorus-containing active ester, epoxy resin, cyanate resin possibly added, SMA resin, and phenolic resin, e.g. 1, 3, 5, 6, 8, 9, 10, 11, 12, 13 or 15 parts by weight, as well as any specific value between said values. Due to space limitations and concise considerations, the present invention no longer enumerates exhaustively the specific point values included in the scope.

The halogen-free thermosetting resin composition of the present invention may further comprise a curing accelerator.

Preferably, the curing accelerator comprises an organometallic salt and anyone selected from the group consisting of imidazole compounds, derivatives of imidazole compounds, piperidine compounds, pyridine compounds, Lewis acid, triphenylphosphine, and a mixture of at least two selected therefrom.

Preferably, the organometallic salt in the curing accelerator comprises any one selected from the group consisting of metal octoates, metal isooctanoates, metal acetylacetonates, metal naphthenates, metal salicylates, metal stearates, and a mixture of at least two selected therefrom, wherein the metal is anyone selected from the group consisting of zinc, copper, iron, tin, cobalt, aluminum, and a mixture of at least two selected therefrom.

Preferably, the imidazole compound is anyone selected from the group consisting of 2-methylimidazole, 2-ethyl-4-methylimidazole, 2-phenylimidazole, 2-undecylimidazole, and a mixture of at least two selected therefrom.

Preferably, the piperidine compound is anyone selected from the group consisting of 2,3-diaminopiperidine, 2,5-diaminopiperidine, 2,6-diaminopiperidine, 2-amino-3-methylpiperidine, 2-amino-4-methylpiperidine, 2-amino-3-nitropiperidine, 2-amino-5-nitropiperidine, 2-amino-4,4-dimethylpiperidine, and a mixture of at least two selected therefrom.

Preferably, the pyridine compound is anyone selected from the group consisting of 4-dimethylaminopyridine, 2-aminopyridine, 3-aminopyridine, 4-aminopyridine, and a mixture of at least two selected therefrom.

Preferably, the curing accelerator is added in an amount of 0.01-1 part by weight, based on 100 parts by weight of the total weight of the phosphorus-containing active ester, epoxy resin, cyanate resin possibly added, SMA resin, and phenolic resin, e.g. 0.01, 0.025, 0.05, 0.07, 0.085, 0.1, 0.3, 0.5, 0.8, 0.9 or 1 part by weight, preferably 0.025-0.85 parts by weight.

The halogen-free thermosetting resin composition of the present invention may further comprise a filler.

Preferably, the filler is selected from the group consisting of an organic or inorganic filler, preferably an inorganic filler, further preferably a surface-treated inorganic filler, most preferably surface-treated silica.

Preferably, the surface treating agent for surface treatment is anyone selected from silane coupling agents, organosilicone oligomers, titanate coupling agents, and a mixture of at least two selected therefrom.

Preferably, the surface treating agent is used in an amount of from 0.1 to 5 parts by weight, preferably from 0.5 to 3 parts by weight, more preferably from 0.75 to 2 parts by weight, based on 100 parts by weight of the inorganic filler.

Preferably, the inorganic filler is anyone selected from the group consisting of non-metal oxides, metal nitrides, non-metal nitrides, inorganic hydrates, inorganic salts, metal hydrates, inorganic phosphorus, and a mixture of at least two selected therefrom, preferably molten silica, crystalline silica, spherical silica, hollow silica, aluminum hydroxide, alumina, talc powder, aluminum nitride, boron nitride, silicon carbide, barium sulfate, barium titanate, strontium titanate, calcium carbonate, calcium silicate, mica, and a mixture of at least two selected therefrom.

Preferably, the organic filler is anyone selected from the group consisting of polytetrafluoroethylene powder, polyphenylene sulfide, polyethersulfone powder, and a mixture of at least two selected therefrom.

Preferably, the filler has a median particle diameter of from 0.01 to 50 μm, preferably from 0.01 to 20 μm, further preferably from 0.1 to 10 μm.

Preferably, the filler is added in an amount of 5 to 300 parts by weight, preferably 5-200 parts by weight, further preferably 5-150 parts by weight, based on 100 parts by weight of the total weight of the phosphorus-containing active ester, epoxy resin, cyanate resin possibly added, SMA resin, and phenolic resin.

The term “comprise(s)/comprising” as used in the present invention means that there may include other components in addition to the above components, and these other components impart different characteristics to the halogen-free thermosetting resin composition. In addition, the term “comprise(s)/comprising” described in the present invention may also be replaced by “are(is)/being” or “consist(s)/consisting of” in a closed manner.

For example, the halogen-free thermosetting resin composition may further contain various additives. Specific examples thereof include antioxidants, heat stabilizers, antistatic agents, ultraviolet absorbers, pigments, colorants or lubricants. These additives may be used alone or in combination of two or more.

The method for the preparation of the halogen-free thermosetting resin composition of the present invention is a conventional technical means in the art, specifically comprising: adding the solids first, then adding the liquid solvent, stirring until the solids are completely dissolved, and then adding the liquid resin and accelerator, continuing to stir evenly.

The solvent in the present invention is not particularly limited. Specific examples thereof include alcohols such as methanol, ethanol and butanol, ethers such as ethyl cellosolve, butyl cellosolve, ethylene glycol methyl ether, carbitol and butyl carbitol, ketones such as acetone, butanone, methyl ethyl ketone and cyclohexanone, aromatic hydrocarbons such as toluene and xylene, esters such as ethyl acetate and ethoxyethyl acetate, as well as nitrogen-containing solvents such as N,N-dimethylformamide or N,N-dimethylacetamide. The solvents above may be used alone or in combination of two or more. Preference is given to ketones such as acetone, butanone, methyl ethyl ketone and cyclohexanone. The amount of the solvent to be added is determined by those skilled in the art according to their own experience, so that the resin glue can reach a viscosity suitable for use.

The prepreg of the present invention comprises a reinforcing material and the halogen-free thermosetting resin composition as described above adhered to the reinforcing material after impregnation and drying. The reinforcing material to be used is not particularly limited and may be an organic fiber, an inorganic fiber woven fabric or non-woven fabric. The organic fiber may be selected from aramid nonwoven fabric, and the inorganic fiber woven fabric may be E-glass fabric, D-glass fabric, S-glass fabric, T-glass fabric, NE-glass fabric or quartz cloth. The thickness of the reinforcing material is not particularly limited. The woven cloth and the nonwoven fabric have a thickness of preferably 0.01 to 0.2 mm for the sake of good dimensional stability of the laminates, and preferably are subjected to fiber-opening treatment and surface treatment with silane coupling agents. In order to provide good water resistance and heat resistance, the silane coupling agent is preferably anyone selected from the group consisting of epoxy silane coupling agents, amino silane coupling agents, vinyl silane coupling agents, and a mixture of at least two selected therefrom. The reinforcing material is impregnated with the halogen-free thermosetting resin composition above, baked at 100-250° C. for 1-15 minutes to obtain said prepreg.

The laminate for printed circuit boards of the present invention comprises a laminate obtained by bonding one or two or more prepregs together by heating and pressurization, and a metal foil bonded to one or both sides of the laminate. The laminate is obtained by curing in a hot press at a curing temperature of 150-250° C. and a curing pressure of 10-60 kg/cm². The metal foil is selected from the group consisting of copper foil, nickel foil, aluminum foil and SUS foil, and the material thereof is not limited.

As compared with the prior art, the present invention has at least the following beneficial effects.

The prepreg and the laminate for printed circuit boards made from the halogen-free thermosetting resin composition provided in the present invention have a glass transition temperature of up to 245° C., excellent dielectric properties, a water absorption rate controlled in the range of 0.06-0.14%, a high heat resistance, excellent heat and humidity resistance and good processability, excellent flame retardant efficiency of UL94 V-0 which can be achieved when P content is 1.5%.

### EMBODIMENTS

The technical solution of the present invention will be further described below by the specific embodiments.

The followings are the specific embodiments of the examples of the present invention. It should be noted that those skilled in the art can make some improvements and refinements without departing from the principles of the examples of the present invention. These improvements and refinements are also considered to be the protection scope of the examples of the present invention.

The embodiments of the present invention are further described below in various examples. The examples of the present invention are not limited to the specific examples below. Modifications can be made appropriately without departing from the scope of the claims.

1. Synthesis of P-AE1

270 g of bis(3-formylchlorophenyl)methylphosphine oxide, 168 g of ODOPB, 147 g of bis(3-hydroxyphenoxy)methylphosphine oxide and 1500 g of pyridine were stirred in a four-necked flask equipped with a stirrer, a reflux condensation tube and a thermometer, while nitrogen gas was introduced. The mixture was then warmed to 30° C. and reacted at such temperature for 4 h. 21 g of benzoyl chloride was further added to the reaction system, and the reaction was also carried out at such temperature for 2 h. The product was cooled to room temperature, and then a 5% sodium carbonate solution was added. The mixture was stirred vigorously, filtered, washed with water and dried to obtain a product numbered as P-AE1.

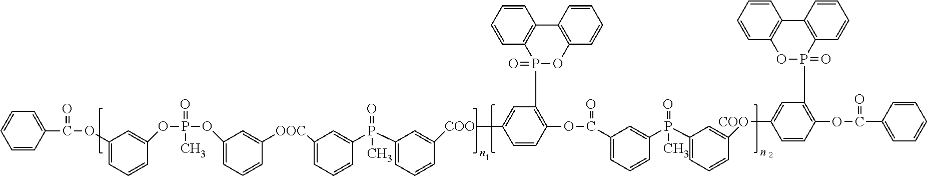

wherein n₁=10, and n₂=10.

2. Synthesis of P-AE2

270 g of bis(4-formylchlorophenyl)methylphosphine oxide, 76.8 g of ODOPB, 269 g of bis(4-hydroxyphenoxy)methylphosphine oxide and 1500 g of pyridine were stirred in a four-necked flask equipped with a stirrer, a reflux condensation tube and a thermometer, while nitrogen gas was introduced. The mixture was then warmed to 30° C. and reacted at such temperature for 4 h. 56 g of benzoyl chloride was further added to the reaction system, and the reaction was also carried out at such temperature for 2 h. The product was cooled to room temperature, and then a 5% sodium carbonate solution was added. The mixture was stirred vigorously, filtered, washed with water and dried to obtain a product numbered as P-AE2.

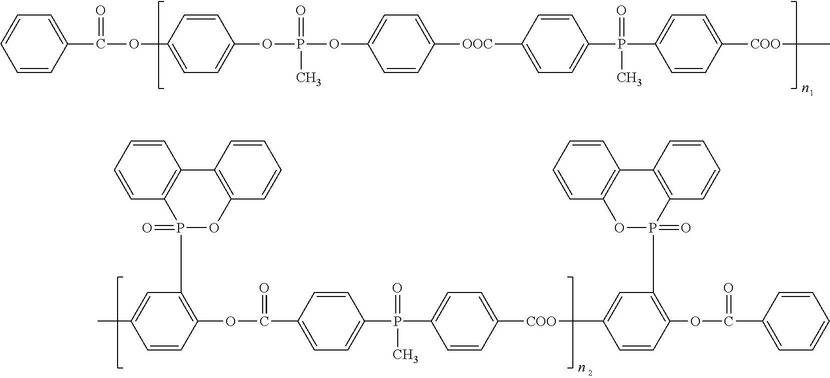

wherein n₁=8, and n₂=2.

3. Synthesis of P-AE3

332 g of bis(4-formylchlorophenyl)methylphosphine oxide, 259 g of ODOPB, 239.4 g of bis(4-hydroxyphenoxy)methylphosphine oxide and 1500 g of pyridine were stirred in a four-necked flask equipped with a stirrer, a reflux condensation tube and a thermometer, while nitrogen gas was introduced. The mixture was then warmed to 30° C. and reacted at such temperature for 4 h. 152 g of naphthoyl chloride was further added to the reaction system, and the reaction was also carried out at such temperature for 2 h. The product was cooled to room temperature, and then a 5% sodium carbonate solution was added. The mixture was stirred vigorously, filtered, washed with water and dried to obtain a product numbered as P-AE3.

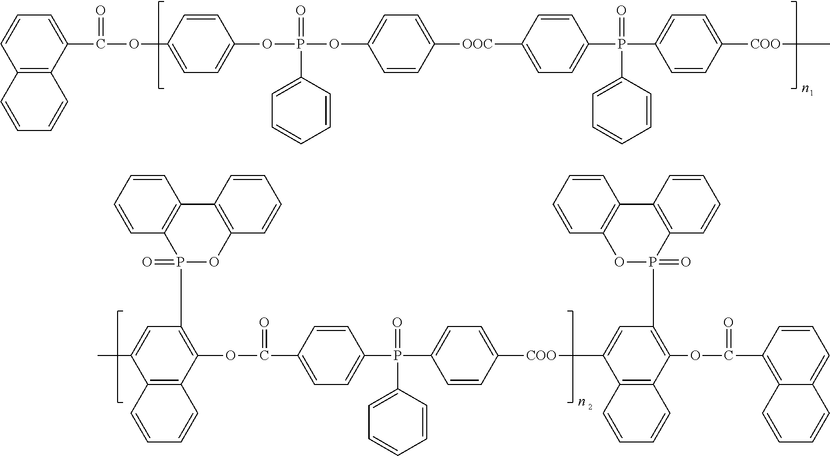

wherein n₁=3, and n₂=3.

4. Synthesis of P-AE4

627 g of bis(4-(4-benzoylchloro)phenylsulfonyl)phenylphosphine oxide, 673 g of 10-(2,7-dihydroxynaphthyl)-10-hydro-9-oxa-10-phosphaphenanthrene-10-oxide and 1500 g of pyridine were stirred in a four-necked flask equipped with a stirrer, a reflux condensation tube and a thermometer, while nitrogen gas was introduced. The mixture was then warmed to 30° C. and reacted at such temperature for 4 h. 352 g of naphthoyl chloride was further added to the reaction system, and the reaction was also carried out at such temperature for 2 h. The product was cooled to room temperature, and then a 5% sodium carbonate solution was added. The mixture was stirred vigorously, filtered, washed with water and dried to obtain a product numbered as P-AE4.

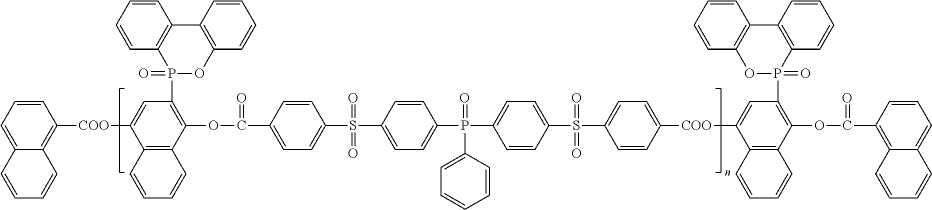

wherein n=3.

5. Synthesis of P-AE5

403 g of bis(4-benzoylchloro)phenylphosphine oxide, 558 g of bis(4-hydroxyphenyl)phenylphosphine oxide and 1500 g of pyridine were stirred in a four-necked flask equipped with a stirrer, a reflux condensation tube and a thermometer, while nitrogen gas was introduced. The mixture was then warmed to 30° C. and reacted at such temperature for 4 h. 238 g of benzoyl chloride was further added to the reaction system, and the reaction was also carried out at such temperature for 2 h. The product was cooled to room temperature, and then a 5% sodium carbonate solution was added. The mixture was stirred vigorously, filtered, washed with water and dried to obtain a product numbered as P-AE5.

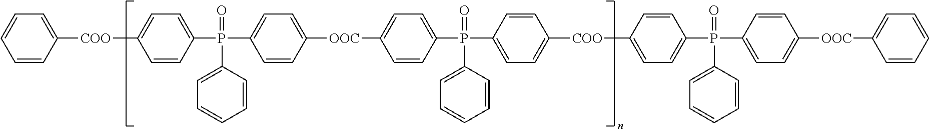

wherein n=3.

6. Synthesis of P-AE6

627 g of bis(4-(4-benzoylchloro)phenylsulfonyl)phenylphosphine oxide, 988 g of bis(4-hydroxybiphenylyloxy)phenylphosphine oxide and 1500 g of pyridine were stirred in a four-necked flask equipped with a stirrer, a reflux condensation tube and a thermometer, while nitrogen gas was introduced. The mixture was then warmed to 30° C. and reacted at such temperature for 4 h. 390 g of benzoyl chloride was further added to the reaction system, and the reaction was also carried out at such temperature for 2 h. The product was cooled to room temperature, and then a 5% sodium carbonate solution was added. The mixture was stirred vigorously, filtered, washed with water and dried to obtain a product numbered as P-AE6.

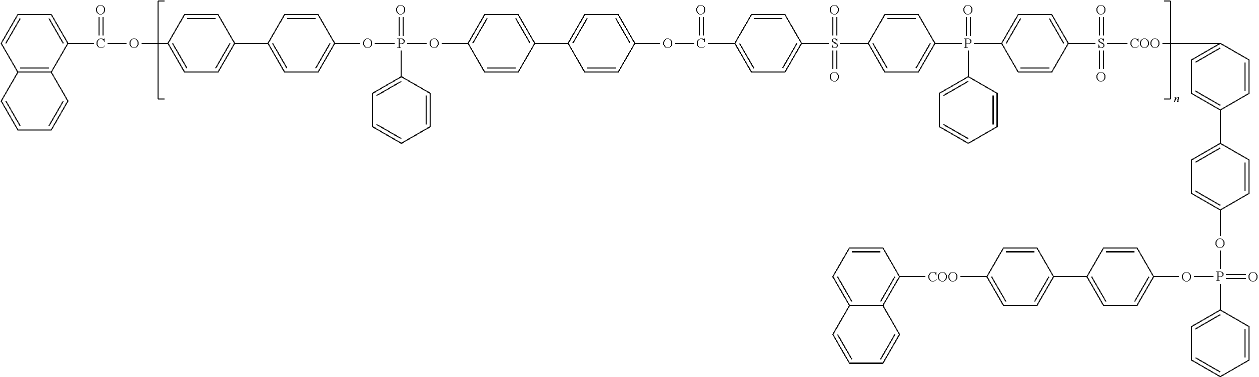

wherein n=1.

The above phosphorus-containing active ester P-AE, a halogen-free epoxy resin and a curing accelerator, a halogen-free flame retardant and a filler were uniformly mixed in a certain ratio in a solvent, and the solid content of the glue was controlled to be 65%. A 2116 fiberglass cloth was impregnated with the above glue to control the appropriate thickness thereof, then was baked in an oven at 115-175° C. for 2-15 minutes to produce a prepreg. Then several prepregs were stacked together, and 18 μm RTF copper foil was stacked on both sides thereof, to produce a copper-clad laminate at a curing temperature of 170-250° C., a curing pressure of 25-60 kg/cm² and a curing time of 60-300 min.

The materials and brand informations thereof in Examples 1-21 and Comparative Examples 1-12 are as follows:

(A)

P-AE1: Self-Made Phosphorus-Containing Active Ester

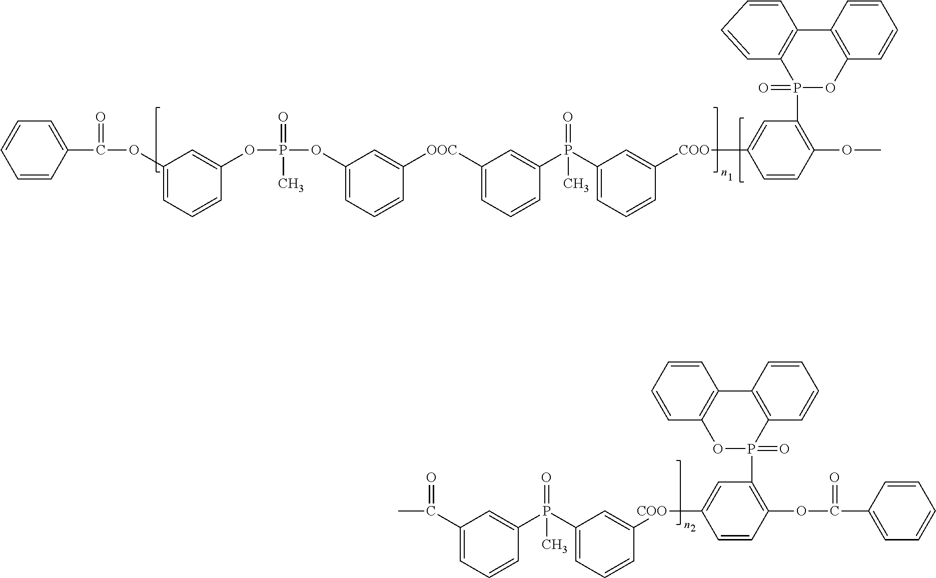

wherein n₁=10, and n₂=10.

P-AE2: Self-Made Phosphorus-Containing Active Ester

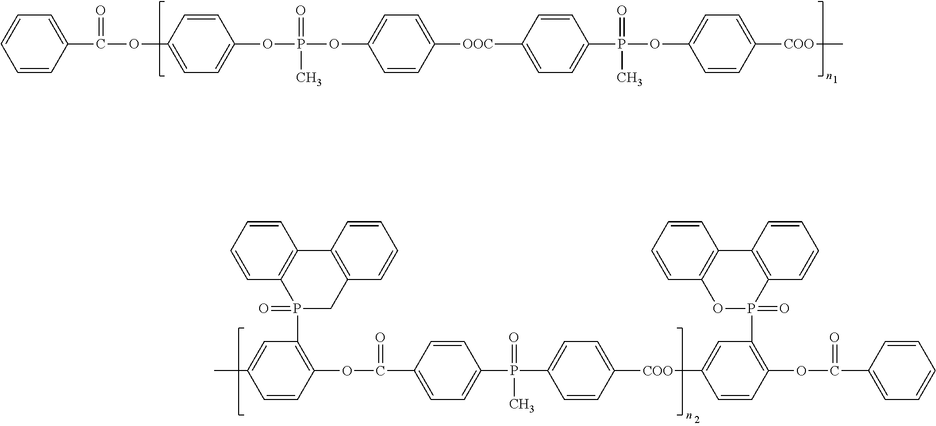

wherein n₁=8, and n₂=2.

P-AE3: Self-Made Phosphorus-Containing Active Ester

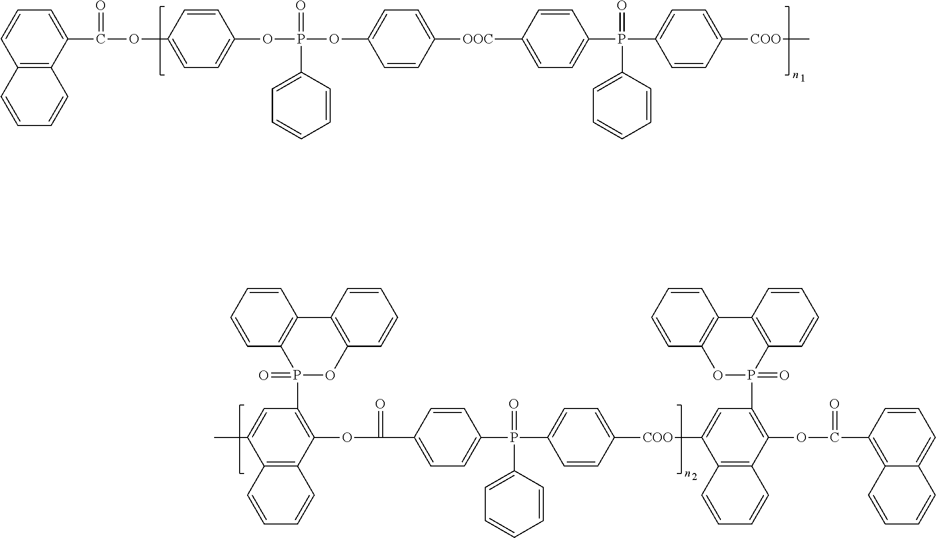

wherein n₁=3, and n₂=3.

P-AE4: Self-Made Phosphorus-Containing Active Ester

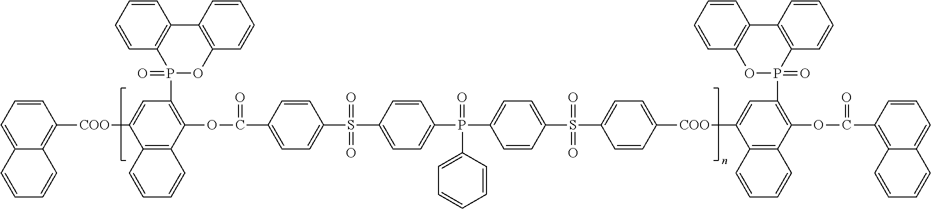

wherein n=3.

P-AE5: Self-Made Phosphorus-Containing Active Ester

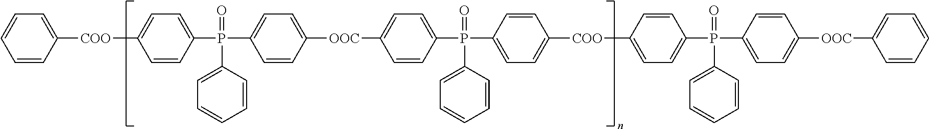

wherein n=3.

P-AE6: Self-Made Phosphorus-Containing Active Ester

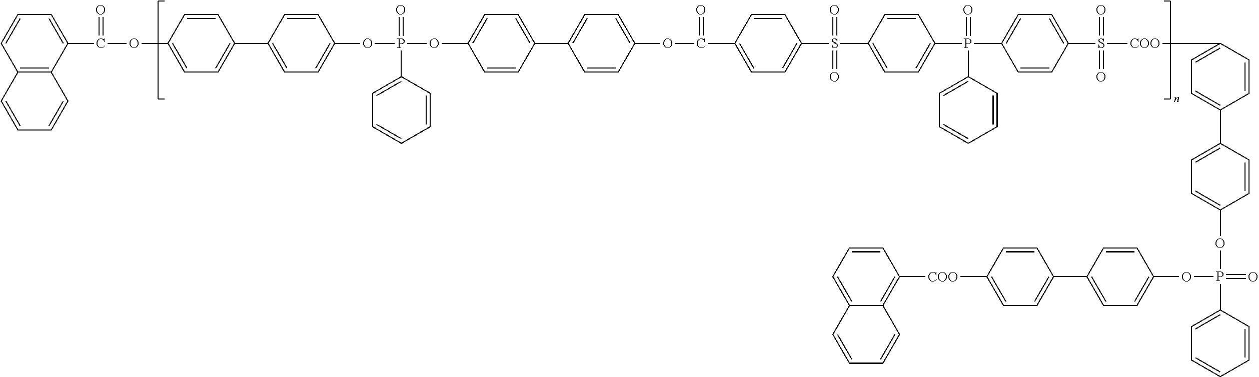

wherein n=1.

BHPPO: Bis(4-hydroxyphenoxy)phenylphosphine oxide

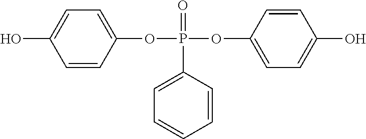 [SMILES: O=P(Oc1ccc(O)cc1)(Oc1ccc(O)cc1)c1ccccc1]

BCPPO: Bis(4-carboxyphenyl)phenylphosphine oxide

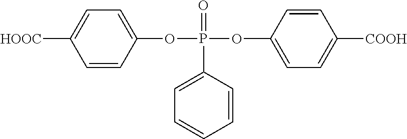 [SMILES: O=C(O)c1ccc(OP(=O)(Oc2ccc(C(=O)O)cc2)c2ccccc2)cc1]

ODOPB: 10-(2,5-dihydroxyphenyl)-10-hydro-9-oxa-10-phosphaphenanthrene-10-oxide

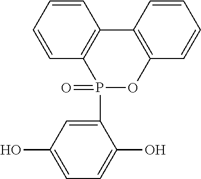 [SMILES: O=P1(c2cc(O)ccc2O)Oc2ccccc2-c2ccccc21]

FRX-3001:

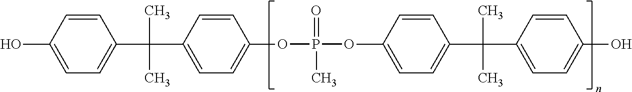

(B) Cyanate

CY-40: Wuqiao resin factory, DCPD-type cyanate resin

PT60S: LONCZ, Novolac type cyanate resin

CE01PS: Jiangsu Tianqi, bisphenol A-type cyanate resin

CE01MO: Jiangsu Tianqi, bisphenol A-type cyanate resin

(C) Epoxy Resin

HP-7200HHH: DIC, DCPD-type epoxy resin having an epoxy equivalent of 288

HP-7200H-75M: DIC, DCPD-type epoxy resin having an epoxy equivalent of 280

HP-6000: DIC, Epoxy resin having an epoxy equivalent of 250

HP-9900: DIC, Naphthol-type epoxy resin having an epoxy equivalent of 274

NC-3000H: Nippon Kayaku, Biphenyl epoxy resin having an epoxy equivalent of 294

SKE-1: Shankote, special epoxy resin having an epoxy equivalent of 120

SKE-3: Shankote, special epoxy resin having an epoxy equivalent of 120

(D) Phenolic Resin

DOW92741: Phosphorus-containing novolac resin, Dow Chemical

SEB-0904PM60: Phosphorus-containing novolac resin, SHIN-A

SHN-1655TM65: Phosphorus-containing novolac resin, SHIN-A

2812: linear novolac resin, MOMENTIVE (Korea)

(E) Phosphorus-Containing Flame Retardant

SPB-100: Otsuka Chemical, phosphazene flame retardant having a phosphorus

content of 13.4%

(F) SMA

EF40: SMA, Sadoma

EF60: SMA, Sadoma

EF80: SMA, Sadoma

EF1000: SMA, Sadoma

(G) Accelerator

2E4MZ: 2-ethyl-4-methylimidazole, Shikoku

DMAP: 4-dimethylaminopyridine, Guangrong Chemical

BICAT Z: zinc isooctanoate, The Shepherd Chemical Company

(H) Filler

Molten silica (having an average particle size of 0.1-10 μm and a purity of 99% or more)

Tables 1-4 involve the formulation compositions and the physical property data of Examples 1-21, and Tables 5-6 involve the formulation compositions and the physical property data of Comparative Examples 1-12.

TABLE 1

| | Example 1 | Example 2 | Example 3 | Example 4 | Example 5 | Example 6 |
|---|---|---|---|---|---|---|
| P-AE1 | 40 | | | | | |
| P-AE2 | | 40 | | | | |
| P-AE3 | | | 45 | | | |
| P-AE4 | | | | 50 | 10 | |
| P-AE5 | | | | | 10 | |
| P-AE6 | | | | | 30 | 60 |
| HP-7200H-75M | | 45 | | | | |
| HP-7200HHH | | | | | | 40 |
| HP-9900 | | | 20 | | | |
| NC-3000H | 60 | | 35 | 50 | 50 | |
| SKE-3 | | 15 | | | | |
| DMAP | 0.01 | 0.05 | 0.1 | 0.2 | 0.2 | 0.5 |
| Spherical silicon | 0 | 25 | 25 | 25 | 25 | 300 |
| P % | 4.28% | 4.31% | 4.99% | 4.17% | 3.18% | 3.07% |
| Tg(DMA)/° C. | 180 | 195 | 185 | 190 | 187 | 185 |
| Dk(10 GHz) | 3.8 | 3.8 | 3.8 | 3.8 | 3.8 | 3.8 |
| Df(10 GHz) | 0.008 | 0.0085 | 0.0083 | 0.0075 | 0.0075 | 0.0075 |
| Water absorption/% | 0.12 | 0.12 | 0.14 | 0.12 | 0.12 | 0.09 |
| PCT/6 h | ◯◯◯ | ◯◯◯ | ◯◯◯ | ◯◯◯ | ◯◯◯ | ◯◯◯ |
| T288/min | >60 | >60 | >60 | >60 | >60 | >60 |
| Flame retardancy | V-0 | V-0 | V-0 | V-0 | V-0 | V-0 |

TABLE 2

| | Example 7 | Example 8 | Example 9 | Example 10 | Example 11 |
|---|---|---|---|---|---|
| P-AE1 | 10 | 30 | 20 | 20 | 40 |
| CE01MO | 50 | | | | |
| CEO1PS | | 40 | | | |
| CY-40 | | | 30 | | |
| PT-60S | | | | 20 | 10 |
| HP-7200HHH | 10 | | | | |
| HP-6000 | | | 50 | | |
| HP-9900 | | | | 60 | |
| NC-3000H | | | | | 50 |
| SKE-1 | 30 | | | | |
| SKE-3 | | 30 | | | |
| SPB-100 | 3.6 | | | | |
| DMAP | 0.01 | 0.08 | 0.1 | 1 | 0.3 |
| Spherical silicon | 100 | 25 | 25 | 25 | 5 |
| P % | 1.50% | 3.21% | 2.14% | 2.14% | 4.28% |
| Tg(DMA)/° C. | 245 | 235 | 205 | 205 | 198 |
| Dk(10 GHz) | 4 | 3.8 | 3.8 | 3.9 | 3.8 |
| Df(10 GHz) | 0.0072 | 0.072 | 0.07 | 0.008 | 0.0075 |
| Water absorption/% | 0.1 | 0.07 | 0.07 | 0.07 | 0.08 |
| PCT/6 h | ◯◯◯ | ◯◯◯ | ◯◯◯ | ◯◯◯ | ◯◯◯ |
| T288/min | >60 | >60 | >60 | >60 | >60 |
| Flame retardancy | V-0 | V-0 | V-0 | V-0 | V-0 |

TABLE 3

| | Example 12 | Example 13 | Example 14 | Example 15 | Example 16 |
|---|---|---|---|---|---|
| P-AE1 | 20 | | | | |
| P-AE2 | | 20 | | 20 | |
| P-AE3 | | | 20 | | |
| P-AE4 | | | | | 50 |
| EF1000 | 20 | | | 25 | 10 |
| EF40 | | 30 | 40 | | |
| EF60 | | | | 15 | |
| EF80 | | | | | 10 |
| HP-6000 | | 50 | | | |
| HP-9900 | 60 | | 40 | | |
| SKE-1 | | | | 30 | |
| SKE-3 | | | | | 30 |
| 2E4MZ | | 0.1 | 0.1 | 0.1 | 0.1 |
| DMAP | 1 | | | | |
| Spherical silicon | 25 | 25 | 25 | 25 | 25 |
| P % | 2.14% | 2.15% | 2.22% | 2.39% | 4.17% |
| Tg(DMA)/° C. | 195 | 180 | 190 | 195 | 198 |
| Dk(10 GHz) | 3.8 | 3.8 | 3.8 | 3.8 | 3.8 |
| Df(10 GHz) | 0.0088 | 0.008 | 0.0075 | 0.0065 | 0.0072 |
| Water absorption/% | 0.09 | 0.09 | 0.09 | 0.06 | 0.07 |
| PCT/6 h | ◯◯◯ | ◯◯◯ | ◯◯◯ | ◯◯◯ | ◯◯◯ |
| T288/min | >60 | >60 | >60 | >60 | >60 |
| Flame retardancy | V-0 | V-0 | V-0 | V-0 | V-0 |

TABLE 4

| | Example 17 | Example 18 | Example 19 | Example 20 | Example 21 |
|---|---|---|---|---|---|
| P-AE1 | 20 | | | | |
| P-AE2 | | | 30 | | |
| P-AE3 | | 25 | | | |
| P-AE4 | | | | 35 | |
| P-AE6 | | | | | 50 |
| DOW92741 | 5 | | | | |
| SEB-0904PM60 | | 5 | | | |
| SHN-1655TM65 | | | | 5 | |
| 2812 | 15 | 15 | 20 | 15 | 5 |
| HP-7200H-M75 | | | | | 45 |
| HP-7200HHH | | | | 45 | |
| HP-6000 | | | 50 | | |
| HP-9900 | | 55 | | | |
| NC-3000H | 60 | | | | |
| 2E4MZ | 0.1 | 0.1 | 0.1 | 0.1 | 0.1 |
| Spherical silicon | 25 | 25 | 25 | 25 | 25 |
| P % | 2.59% | 3.27% | 3.23% | 3.27% | 2.56% |
| Tg(DMA)/° C. | 180 | 185 | 180 | 190 | 195 |
| Dk(10 GHz) | 3.8 | 3.8 | 3.8 | 3.8 | 3.8 |
| Df(10 GHz) | 0.008 | 0.0075 | 0.0075 | 0.0085 | 0.007 |
| Water absorption/% | 0.08 | 0.08 | 0.08 | 0.08 | 0.085 |
| PCT/6 h | ◯◯◯ | ◯◯◯ | ◯◯◯ | ◯◯◯ | ◯◯◯ |
| T288/min | >60 | >60 | >60 | >60 | >60 |
| Flame retardancy | V-0 | V-0 | V-0 | V-0 | V-0 |

TABLE 5

| | Comp. | Comp. | Comp. | Comp. | Comp. | Comp. |
|---|---|---|---|---|---|---|
| | Example 1 | Example 2 | Example 3 | Example 4 | Example 5 | Example 6 |
| P-AE6 | | | | | | |
| ODOPB | 60 | 20 | 20 | 35 | | |
| FRX3001 | | | | | 60 | 20 |
| CY-40 | | 30 | | | | 30 |
| EF40 | | | 30 | | | |
| SHN-1655TM65 | | | | 5 | | |
| 2812 | | | | 15 | | |
| HP-7200HHH | 40 | | | 45 | 40 | |
| HP-6000 | | 50 | 50 | | | 50 |
| 2E4MZ | | | 0.1 | 0.1 | | |
| DMAP | 0.5 | 0.1 | | | 0.5 | 0.1 |
| Spherical silicon | 300 | 25 | 25 | 25 | 300 | 25 |
| P % | 5.81% | 1.94% | 1.94% | 3.74% | 6.00% | 2.00% |
| Tg (DMA)/° C. | 180 | ODOPB is too | 180 | 170 | FRX-3001 | 180 |
| Dk (10 GHz) | 4.3 | high in | 4.2 | 4.3 | has low | 4 |
| Df (10 GHz) | 0.014 | catalytic | 0.011 | 0.0011 | activity, | 0.0095 |
| Water absorption/% | 0.2 | activity for | 0.12 | 0.4 | resulting in | 0.1 |
| PCT/6 h | XXX | cyanate esters, | XXX | XXX | failure to | XXX |
| T288/min | 15 | resulting in | 32 | 24 | form sheet | 45 |
| Flame retardancy | V-0 | failure to form | V-0 | V-0 | | V-1 |
| | | sheets | | | | |

TABLE 6

| | | | | | | Comp. |
|---|---|---|---|---|---|---|
| | Comp. | Comp. | Comp. | Comp. | Comp. | Example |
| | Example 7 | Example 8 | Example 9 | Example 10 | Example 11 | 12 |
| P-AE6 | 70 | 9 | | | | |
| ODOPB | | | | | | 30 |
| BHPPO | | | 60 | | 30 | |
| BCPPO | | | | 60 | 30 | 30 |
| FRX3001 | | | | | | |
| CY-40 | | | | | | |
| EF40 | | | | | | |
| SHN-1655TM65 | | | | | | |
| 2812 | | | | | | |
| HP-7200HHH | 30 | 91 | 40 | 40 | 40 | 40 |
| HP-6000 | | | | | | |
| 2E4MZ | | | | | | |
| DMAP | 0.5 | 0.5 | 0.5 | 0.5 | 0.5 | 0.5 |
| Spherical silicon | 300 | 300 | 300 | 300 | 300 | 300 |
| P % | 3.54% | 0.45% | 5.44% | 5.08% | 5.26% | 5.45% |
| Tg(DMA)/° C. | 170 | Insufficient | 180 | 185 | 160 | 170 |
| Dk(10 GHz) | 4.3 | curing agent, | 4.3 | 4.3 | 4.3 | 4.3 |
| Df(10 GHz) | 0.014 | resulting in | 0.014 | 0.012 | 0.014 | 0.012 |
| Water | 0.2 | failure to | 0.2 | 0.15 | 0.2 | 0.15 |
| absorption/% | | form sheets | | | | |
| PCT/6 h | XXX | | XXX | XXX | XXX | XXX |
| T288/min | 15 | | 5 | 15 | 1.5 | 3 |
| Flame | V-0 | | V-0 | V-0 | V-0 | V-0 |
| retardancy | | | | | | |

Additional descriptions of the PCT/6 h performance icons: “x” represents that delamination and popcorn occurred, “O” represents that delamination and popcorn did not occur.

The above characteristics are tested as follows.

(1) Glass transition temperature (Tg): Determined according to the DMC method specified in IPC-TM-650 2.4.24.

(2) Dielectric constant and dielectric loss factor: Tested according to the SPDR method.

(3) Evaluation of heat and humidity resistance (PCT): The copper foil on the surface of the copper-clad laminate was etched and the substrate was evaluated. The substrate was placed in a pressure cooker and treated at 120° C. and 105 KPa for 6 h, and then immersed in a tin furnace at 288° C. When there was delamination and popcorn, the corresponding time was recorded. When the substrate had not been bubbled or delaminated in the tin furnace for more than 5 min, the evaluation could be ended.

(4) T288: tested with a TMA instrument according to the T300 test method specified in IPC-TM-650 2.4.24.1.

(5) Water Absorption: tested according to the test method specified in IPC-TM-650 2.6.2.1.

(6) Flame retardancy: tested according to the UL standard method.

From the comparisons of the data in Tables 1-6, the followings can be noted.

By comparing Comparative Example 1 with Example 6, it can be seen that the copper-clad laminate prepared by using ODOBP and the halogen-free epoxy resin in Comparative Example 1 has worse dielectric properties, poor heat resistance and heat and humidity resistance, high water absorption rate and low Tg. By comparing Comparative Example 2 with Example 9, it can be seen that ODOBP and cyanate resin were used together in Comparative Example 2 to cure the halogen-free epoxy resin, and the catalytic activity of ODOPB to cyanate resin was too high, resulting in failure to form a sheet. By comparing Comparative Example 3 with Example 13, it can be seen that the copper-clad laminate prepared by curing the halogen-free epoxy resin with ODOBP and SMA resin in Comparative Example 3 has worse dielectric properties, poor heat resistance and heat and humidity resistance, and high water absorption rate. By comparing Comparative Example 4 with Example 20, it can be seen that the copper-clad laminate prepared by curing the halogen-free epoxy resin with ODOBP and phenolic resin in Comparative Example 4 has worse dielectric properties, poor heat resistance and heat and humidity resistance, high water absorption rate and low Tg. By comparing Comparative Example 5 with Examples 6, it can be seen that FRX3001 is used to cure the halogen-free epoxy resin in Example 5; due to poor reactivity and low OH⁻ content of FRX3001, the copper-clad laminates cannot be made. By comparing Comparative Example 6 with Example 9, it can be seen that the copper-clad laminate prepared by curing the halogen-free epoxy resin with FRX3001 and cyanate resin in Comparative Example 6 has worse dielectric properties, low Tg, poor heat resistance and heat and humidity resistance, high water absorption and poor flame retardancy.

Further, it can be seen by comparing Comparative Example 7 with Example 6 that the copper-clad laminate prepared in Comparative Example 7 from phosphorus-containing active ester in a content higher than that in Example 6 has high water absorption rate, heat resistance and heat and humidity resistance. By comparing Comparative Example 8 with Example 6, it can be seen that, when the phosphorus-containing active ester is used in Comparative Example 8 in a content higher than that in Example 6, laminates cannot be made due to insufficient curing agent.

By comparing Comparative Example 9 with Example 6, it can be seen that the copper-clad laminate prepared from BHPPO and the halogen-free epoxy resin in Comparative Example 9 has worse dielectric properties, poor heat resistance and heat and humidity resistance, high water absorption rate and low Tg. By comparing Comparative Example 10 with Example 6, it can be seen that the copper-clad laminate prepared from BCPPO and the halogen-free epoxy resin in Comparative Example 10 has worse dielectric properties, poor heat resistance and heat and humidity resistance and high water absorption rate.

In Comparative Examples 11 and 12, organic carboxylic acid and phenol are used together as an epoxy curing agent. Due to higher rate difference of the reaction between carboxylic acid and epoxy and between phenol and epoxy, carboxylic acid rapidly participates in the curing reaction as a result, while phenol hardly participates in the reaction in the system or in a low amount. It acts as a plasticizer in the curing system, resulting in an extremely low Tg after curing and a low T288. Moreover, due to the presence of phenolic hydroxyl group with a high polarity, there are shortcomings such as poor dielectric properties and high water absorption rate.

From the above results, it can be seen that, by replacing ODOBP and FRX as well as BHPPO and BCPPO with the phosphorus-containing active ester of the present invention, the prepregs and laminates for printed circuit boards made from the active ester and components such as a halogen-free epoxy resin have a glass transition temperature of up to 245° C., excellent dielectric properties, water absorption controlled in the range of 0.06-0.14%, high heat resistance, excellent heat and humidity resistance and good processability, excellent flame retardant efficiency, and can achieve UL94 V-0 when P content is 1.5%.

As described above, as compared with general laminates, the prepregs and laminates for printed circuit boards made from the halogen-free thermosetting resin composition provided by the present invention have high glass transition temperature, excellent dielectric properties, low water absorption, high heat resistance, excellent heat and humidity resistance and good processability, and can achieve halogen-free flame retardancy and reach UL94 V-0.

The above-described examples are merely preferred examples of the present invention. Those ordinarily skilled in the art can make various other corresponding changes and modifications in accordance with the technical solutions and technical concept of the present invention, and all such changes and modifications shall fall within the scope of the claims of the present invention.

1-8. (canceled)

9. A thermosetting resin composition, comprising:
I) a curing agent comprising at least one phosphorus-containing active ester, wherein the phosphorus-containing active ester is present in an amount of 10% to 60% by weight of the total weight of an epoxy resin and the curing agent in the thermosetting resin composition,
the phosphorus-containing active ester is obtained by copolymerizing a diarylformylchlorohydrocarbylphosphine oxide with at least one of a dihydroxyarylhydrocarbylphosphine oxide, a dihydroxyaryloxyhydrocarbylphosphine oxide and a hydroxylated DOPO, and then terminating by an aromatic formyl chloride, wherein
the diarylformylchlorohydrocarbylphosphine oxide has a structural formula of Formula (I), 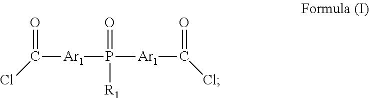
the dihydroxyarylhydrocarbylphosphine oxide has a structural formula of Formula (II), 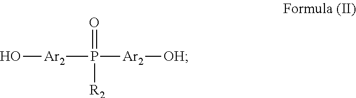
the dihydroxyaryloxyhydrocarbylphosphine oxide has a structural formula of Formula (III), 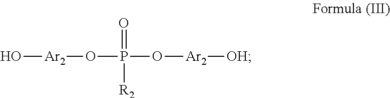
the hydroxylated DOPO has a structural formula of Formula (IV), 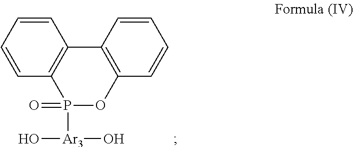
the aromatic formyl chloride has a structural formula of Formula (V), 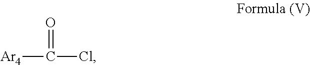
wherein R₁ and R₂ are identical or different from each other, and each independently anyone selected from the group consisting of phenyl, naphthyl, and linear or branched alkyl having 1 to 4 carbon atoms;
wherein Ar₁ and Ar₂ are identical or different from each other, and each independently anyone selected from the group consisting of 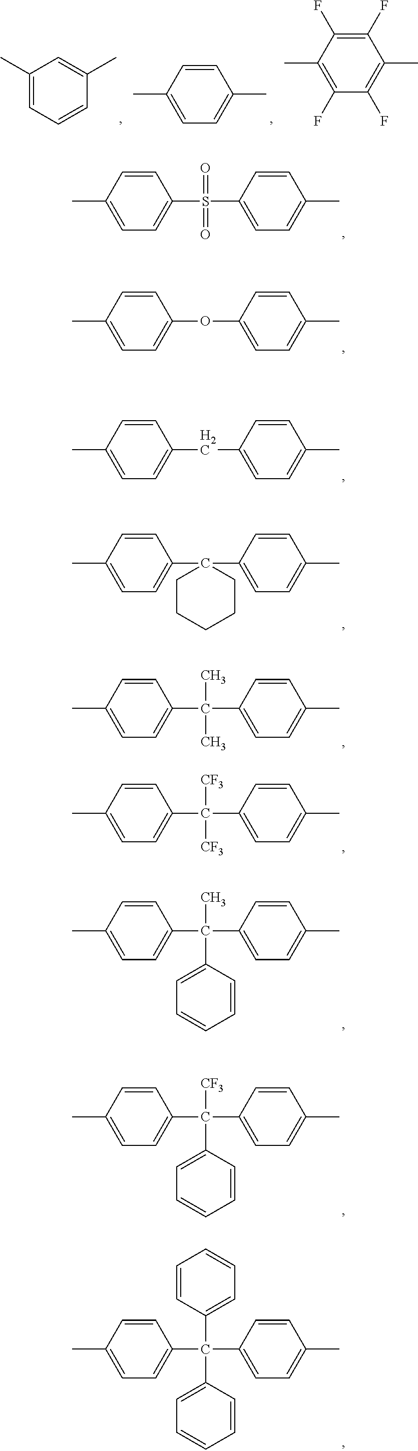 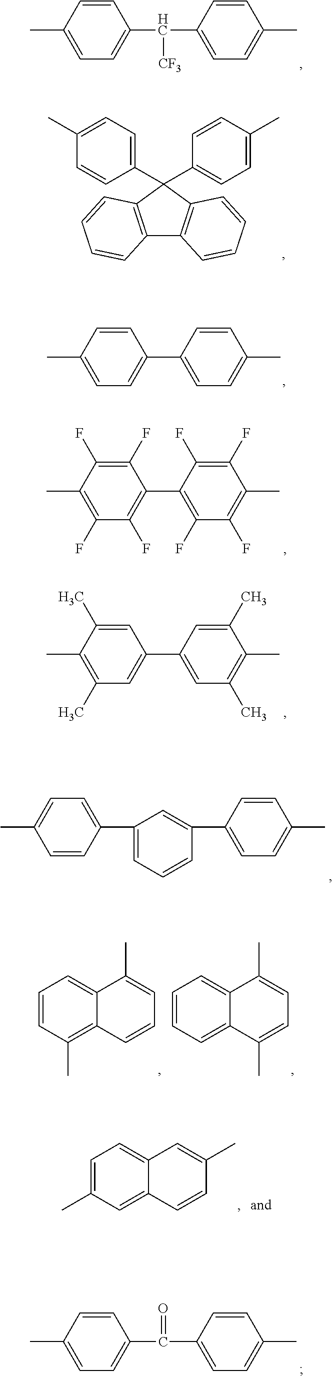
wherein Ar₃ is anyone selected from the group consisting of 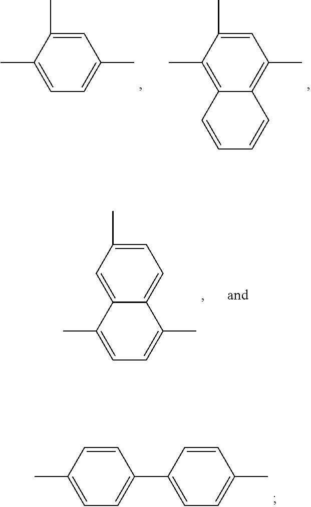
wherein Ar₄ is anyone selected from the group consisting of 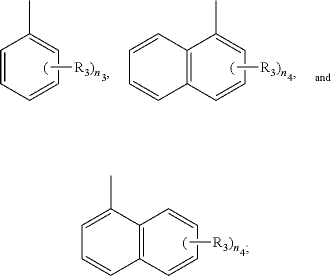
wherein n₃ is an integer of 0-5;
wherein n₄ is an integer of 0-7;
wherein R₃ is anyone selected from the group consisting of linear or branched alkyl groups having 1 to 4 carbon atoms;
II) an epoxy resin present in an amount of 30% to 60% by weight of the total weight of the epoxy resin and the curing agent in the thermosetting resin composition.

10. The thermosetting resin composition claimed in claim 9, wherein the phosphorus-containing active ester is obtained by copolymerizing a diarylformylchlorohydrocarbylphosphine oxide with a dihydroxyarylhydrocarbylphosphine oxide and then terminating by an aromatic formyl chloride, wherein the phosphorus-containing active ester has a structural formula of formula (VI), 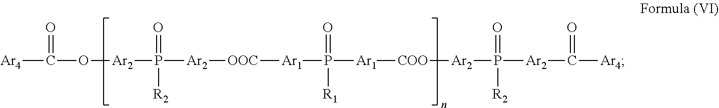
wherein n is an integer of 1-20;
wherein R₁ and R₂ are identical or different from each other, and each independently anyone selected from the group consisting of phenyl, naphthyl, and linear or branched alkyl having 1 to 4 carbon atoms;
wherein Ar₁ and Ar₂ are identical or different from each other, and each independently anyone selected from the group consisting of 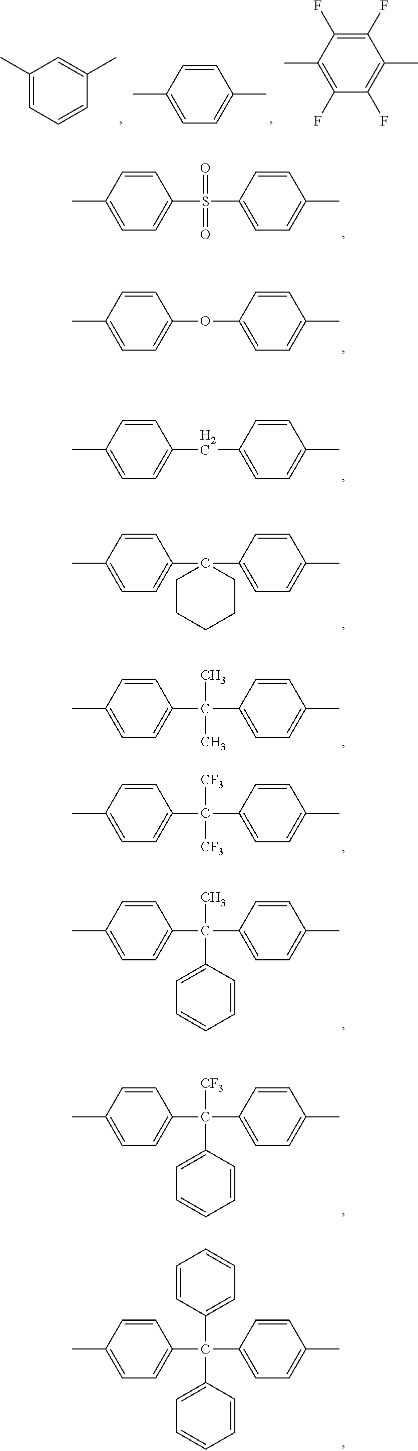 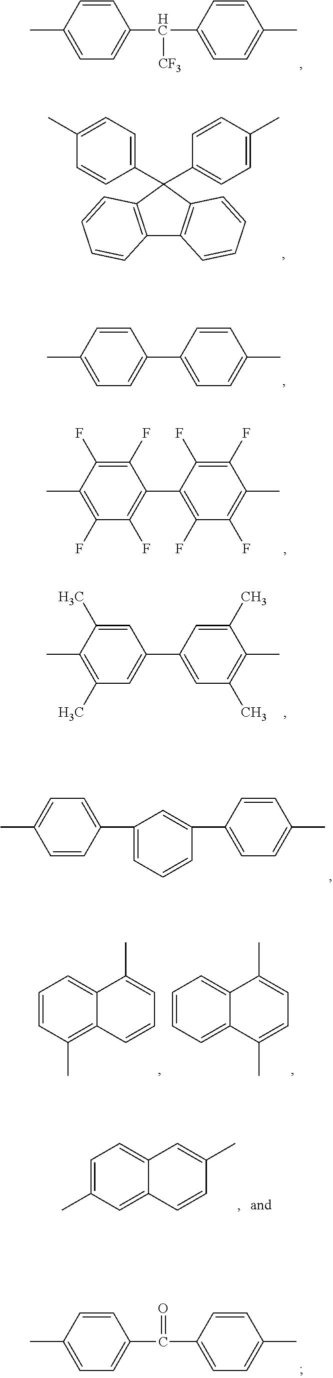
wherein Ar₄ is anyone selected from the group consisting of 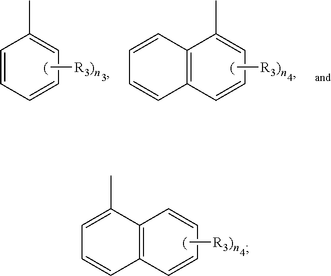
wherein n₃ is an integer of 0-5;
wherein n₄ is an integer of 0-7;
wherein R₃ is anyone selected from the group consisting of linear or branched alkyl groups having 1 to 4 carbon atoms.

11. The thermosetting resin composition claimed in claim 9, wherein the phosphorus-containing active ester is obtained by copolymerizing a diarylformylchlorohydrocarbylphosphine oxide with a dihydroxyaryloxyhydrocarbylphosphine oxide and then terminating by an aromatic formyl chloride, wherein the phosphorus-containing active ester has a structural formula of formula (VII), 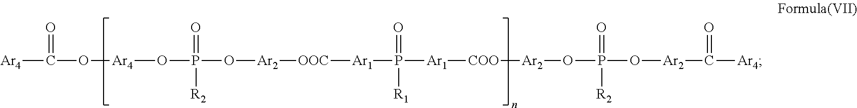
wherein n is an integer of 1-20;
wherein R₁ and R₂ are identical or different from each other, and each independently anyone selected from the group consisting of phenyl, naphthyl, and linear or branched alkyl having 1 to 4 carbon atoms;
wherein Ar₁ and Ar₂ are identical or different from each other, and each independently anyone selected from the group consisting of 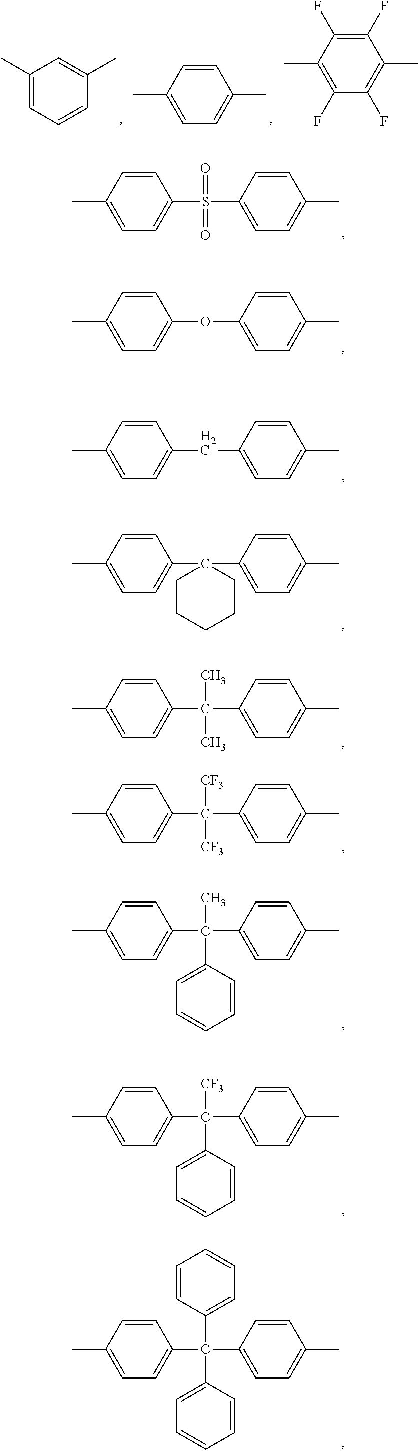 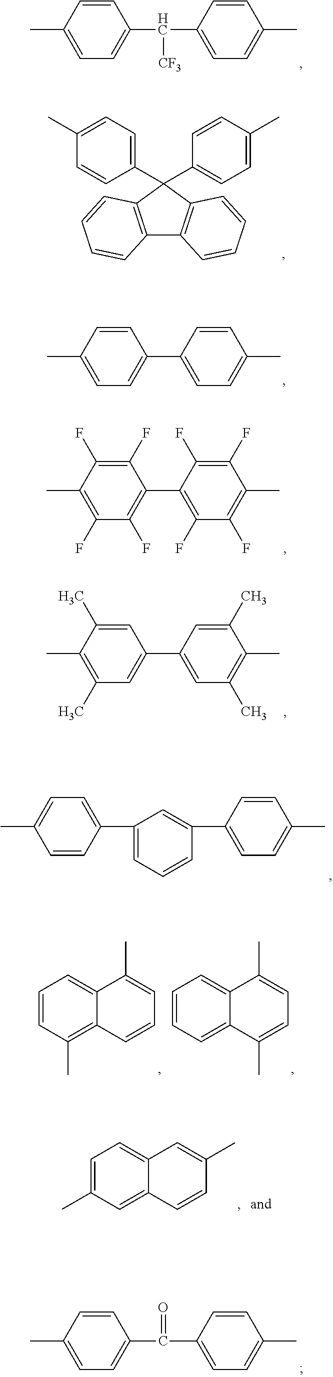
wherein Ar₄ is anyone selected from the group consisting of 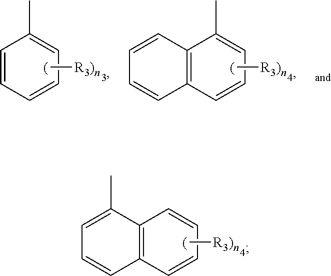
wherein n₃ is an integer of 0-5;
wherein n₄ is an integer of 0-7;
wherein R₃ is anyone selected from the group consisting of linear or branched alkyl groups having 1 to 4 carbon atoms.

12. The thermosetting resin composition claimed in claim 9, wherein the phosphorus-containing active ester is obtained by copolymerizing a diarylformylchlorohydrocarbylphosphine oxide with a hydroxylated DOPO and then terminating by an aromatic formyl chloride, wherein the phosphorus-containing active ester has a structural formula of formula (VIII), 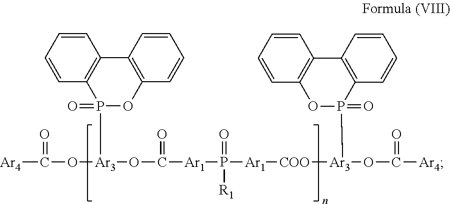
wherein n is an integer of 1-20;
wherein R₁ is anyone selected from the group consisting of phenyl, naphthyl, and linear or branched alkyl having 1 to 4 carbon atoms;
wherein Ar₁ is anyone selected from the group consisting of 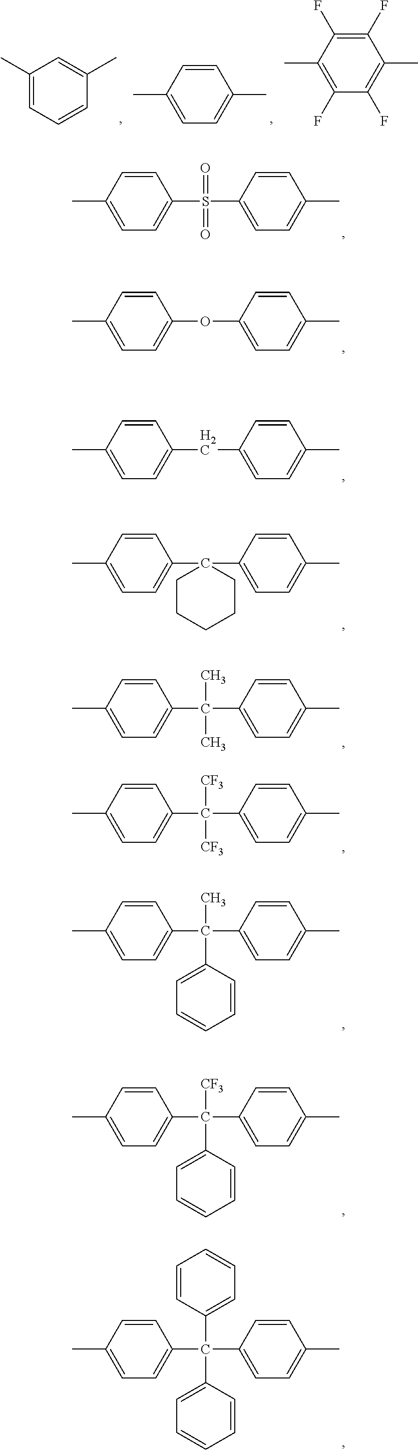 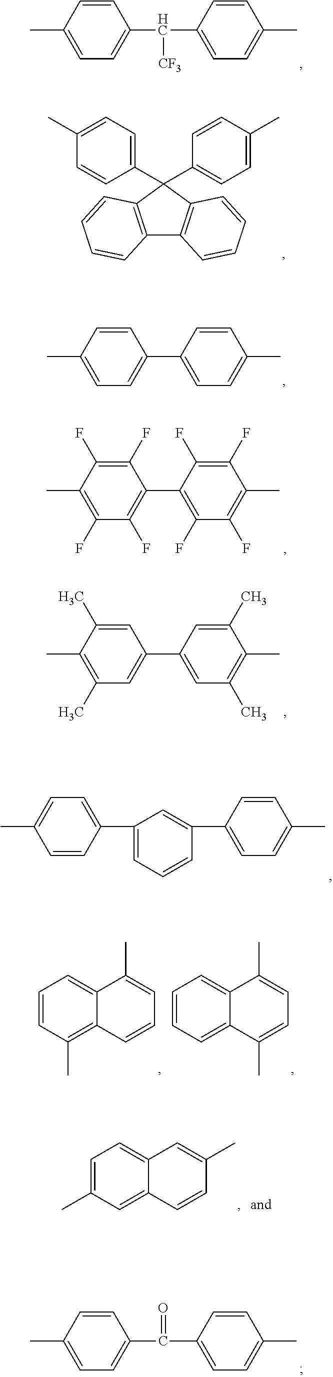
wherein Ar₂ is anyone selected from the group consisting of 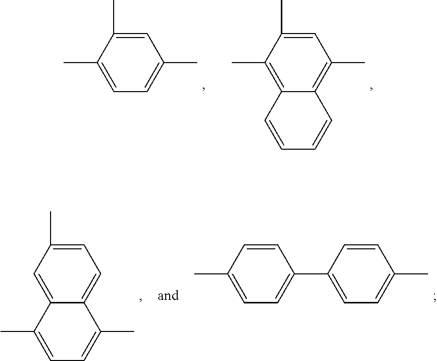
wherein Ar₄ is anyone selected from the group consisting of 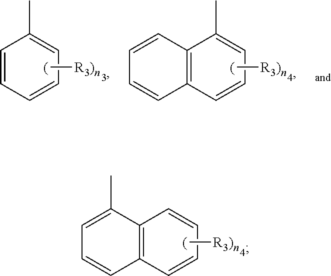
wherein n₃ is an integer of 0-5;
wherein n₄ is an integer of 0-7;
wherein R₃ is anyone selected from the group consisting of linear or branched alkyl groups having 1 to 4 carbon atoms.

13. The thermosetting resin composition claimed in claim 9, wherein the phosphorus-containing active ester is obtained by copolymerizing a diarylformylchlorohydrocarbylphosphine oxide with a dihydroxyaryloxyhydrocarbylphosphine oxide and a hydroxylated DOPO and then terminating by an aromatic formyl chloride, wherein the phosphorus-containing active ester has a structural formula of formula (IX) or (X), 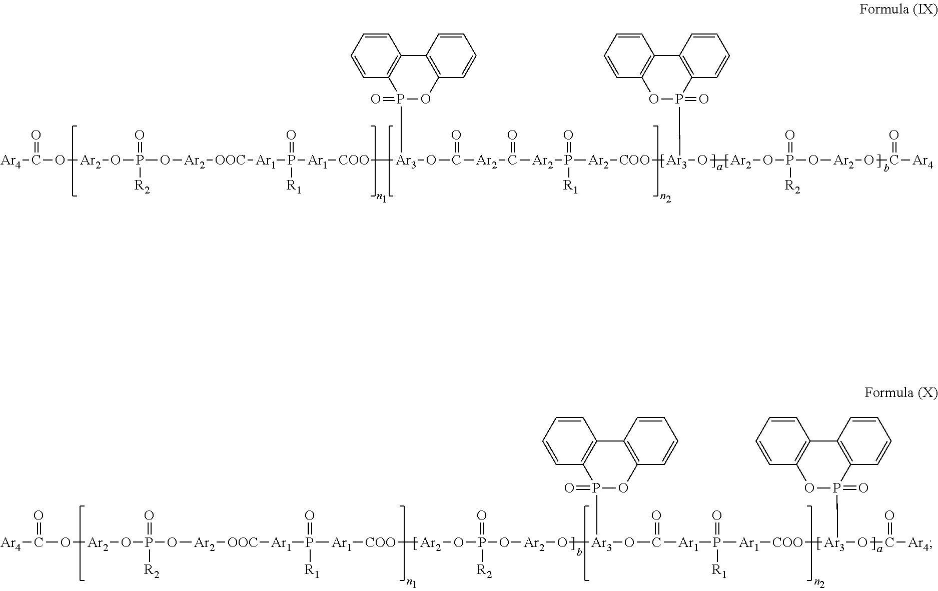
wherein each of n₁ and n₂ is an integer of 0-20, and 1≤n₁+n₂≤20;
wherein each of a and b is 0 or 1, and a+b=1;
wherein b must be 0 when n₁ is 0;
wherein a must be 0 when n₂ is 0;
wherein R₁ and R₂ are identical or different from each other, and each independently anyone selected from the group consisting of phenyl, naphthyl, and linear or branched alkyl having 1 to 4 carbon atoms;
wherein Ar₁ and Ar₂ are identical or different from each other, and each independently anyone selected from the group consisting of 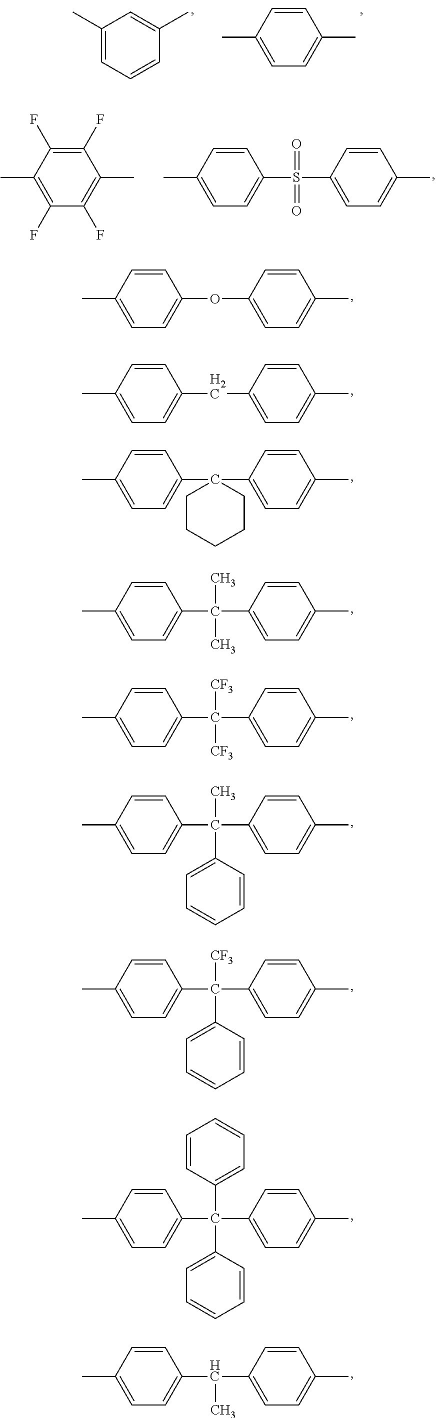 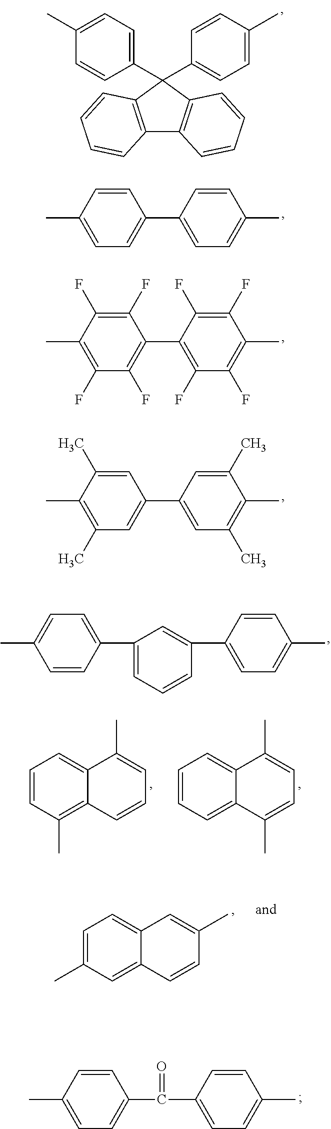
wherein Ar₃ is anyone selected from the group consisting of 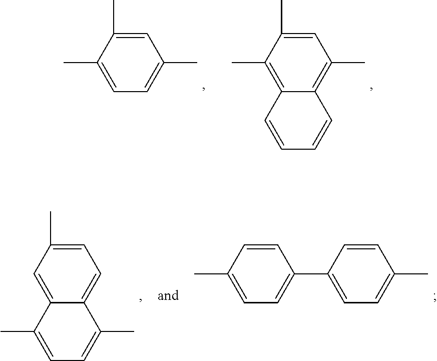
wherein Ar₄ is anyone selected from the group consisting of 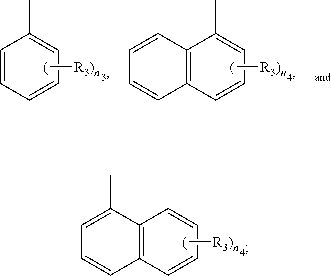
wherein n₃ is an integer of 0-5;
wherein n₄ is an integer of 0-7;
wherein R₃ is anyone selected from the group consisting of linear or branched alkyl groups having 1 to 4 carbon atoms.

14. The thermosetting resin composition claimed in claim 9, wherein the curing agent further comprises a cyanate resin and/or a bismaleimide-triazine resin;
the cyanate resin and/or the bismaleimide-triazine resin are/is present in an amount of 0%-50% by weight of the total weight of the epoxy resin and the curing agent in the thermosetting resin composition.

15. The thermosetting resin composition claimed in claim 9, wherein the curing agent further comprises a SMA resin;
the SMA resin is present in an amount of 0%-40% by weight of the total weight of the epoxy resin and the curing agent in the thermosetting resin composition.

16. The thermosetting resin composition claimed in claim 9, wherein the curing agent further comprises a phenolic resin; the phenolic resin is present in an amount of 0%-20% by weight of the total weight of the epoxy resin and the curing agent in the thermosetting resin composition.

17. The thermosetting resin composition claimed in claim 9, wherein the curing agent further comprises an organic halogen-free flame retardant;
the organic halogen-free flame retardant is present in an amount of 0-15 parts by weight, based on 100 parts by weight of the total weight of the epoxy resin and the curing agent in the thermosetting resin composition.

18. The thermosetting resin composition claimed in claim 9, wherein the thermosetting resin composition further comprises a filler and/or an accelerator.

19. The method for using the thermosetting resin composition claimed in claim 1 in resin sheet materials, resin composite metal foils, prepregs, laminates, metal foil-clad laminates and printed circuit boards.
